(19) United States
(12) Patent Application Publication
(10) Pub. No.: US 2025/0364725 A1
(43) Pub. Date: Nov. 27, 2025

(54) RADIO WAVE REFLECTING SYSTEM

(71) Applicant: Japan Display Inc., Tokyo (JP)

(72) Inventors: Masayuki IKARI, Tokyo (JP); Daijiro TAKANO, Tokyo (JP); Mitsuhiro SUGAWARA, Tokyo (JP)

(73) Assignee: Japan Display Inc., Tokyo (JP)

(21) Appl. No.: 19/293,017

(22) Filed: Aug. 7, 2025

Related U.S. Application Data
(63) Continuation of application No. PCT/JP2023/046906, filed on Dec. 27, 2023.

(30) Foreign Application Priority Data
Feb. 24, 2023 (JP) 2023-027693

(51) Int. Cl. H01Q 15/14; G02F 1/13; G02F 1/137; H01Q 9/04

(52) U.S. Cl. CPC H01Q 15/14; G02F 1/1313; G02F 1/13706; H01Q 9/0407

(57) ABSTRACT

A radio wave reflection system includes an intelligent reflecting surface including a plurality of patch electrodes, an electrode layer, and a liquid crystal layer, and a driver IC electrically connected to the plurality of patch electrodes and including an output signal generating unit and a timing pattern signal generating unit electrically connected to the output signal generating unit. The timing pattern signal generating unit generates a plurality of pattern signals including voltage values corresponding to each of a plurality of predetermined phase values using an address signal indicating a position where the intelligent reflecting surface is to be placed, a power supply voltage, and a pattern selection signal selecting a plurality of parameters including a plurality of predetermined phase values. The output signal generating unit generates a plurality of output signals based on each of the plurality of pattern signals using the plurality of pattern signals.

### CROSS-REFFERENCE TO RELATED APPLICATIONS

This application is a Continuation of International Patent Application No. PCT/JP2023/046906, filed on Dec. 27, 2023, which claims the benefit of priority to Japanese Patent Application No. 2023-027693, filed on Feb. 24, 2023, the entire contents of each are incorporated herein by reference.

### FIELD

An embodiment of the present invention relates to a radio wave reflecting system that can display an image and control a traveling direction of reflected radio waves.

The introduction of the fifth-generation communication standard called 5G is advancing in the communication field. Frequencies in the millimeter-wave band (26GHz or higher, e.g., 26 GHz to 29 GHz) are employed in this communication standard. Communication according to the 5G standard can achieve very high-throughput by adopting a millimeter-wave band frequency, and can be transmitted over a wide bandwidth.

For example, to change a transmission direction of a radio wave and to widen the communication area while avoiding an obstacle, an attempt is made to use a metasurface in communication according to the 5G standard. The metasurface includes a plurality of antenna elements arranged in a plane. A signal including a voltage corresponding to a predetermined phase is transmitted to each of the plurality of antenna elements. As a result, the metasurface can control the directivity of the antenna in a state where each of the plurality of antenna elements is fixed. For example, there is known a metasurface that adjusts an amplitude and a phase of a high-frequency signal transmitted to each of the plurality of antenna elements and utilizes a change in dielectric constant due to an alignment state of a liquid crystal.

### SUMMARY

A radio wave reflecting system includes an intelligent reflecting surface including a plurality of patch electrodes arranged in a matrix in a first direction and a second direction intersecting the first direction, an electrode layer facing and spaced apart from the plurality of patch electrodes, and a liquid crystal layer provided between the plurality of patch electrodes and the electrode layer, and a driver IC electrically connected to the plurality of patch electrodes including an output signal generating unit and a timing pattern signal generating unit electrically connected to the output signal generating unit. The timing pattern signal generating unit is configured to generate a plurality of pattern signals including voltage values corresponding to each of a plurality of predetermined phase values using an address signal indicating a position where the intelligent reflecting surface is arranged, a power supply voltage, and a pattern selection signal selecting a plurality of parameters including the plurality of predetermined phase values. The output signal generating unit is configured to generate a plurality of output signals based on each of the plurality of pattern signals using the plurality of pattern signals, and to supply each of the plurality of output signals to the corresponding plurality of patch electrodes.

A radio wave reflecting system includes an intelligent reflecting surface including a plurality of patch electrodes arranged in a matrix in a first direction and a second direction intersecting the first direction, an electrode layer facing and spaced apart from the plurality of patch electrodes, and a liquid crystal layer provided between the plurality of patch electrodes and the electrode layer, a driver IC electrically connected to the plurality of patch electrodes, and a circuit board electrically connected to the driver IC and including a timing pattern signal generating unit. The timing pattern signal generating unit is configured to generate a plurality of pattern signals including voltage values corresponding to each of a plurality of predetermined phase values using an address signal indicating a position where the intelligent reflecting surface is arranged, a power supply voltage, and a pattern selection signal selecting a plurality of parameters including the plurality of predetermined phase values. The driver IC is configured to generate a plurality of output signals based on each of the plurality of pattern signals using the plurality of pattern signals, and to supply each of the plurality of output signals to the corresponding plurality of patch electrodes.

A radio wave reflecting system includes a first radio wave reflecting device, a second radio wave reflecting device arranged alongside the first radio wave reflecting device along a second direction intersecting a first direction, a third radio wave reflecting device arranged alongside the first radio wave reflecting device along the first direction, a fourth radio wave reflecting device arranged alongside the second radio wave reflecting device along the first direction and alongside the third radio wave reflecting device along the second direction, a first circuit board connected to the first radio wave reflecting device and the second radio wave reflecting device; and a second circuit board connected to the third radio wave reflecting device and the fourth radio wave reflecting device. Each of the first circuit board and the second circuit board includes an address signal generating unit and a power supply circuit. The address signal generating unit is configured to generate an address signal indicating positions where the first to fourth radio wave reflecting devices are arranged using a pattern selection signal for selecting a plurality of parameters including a plurality of predetermined phase values. The power supply circuit is configured to generate a power supply voltage. Each of the first circuit board and the second circuit board is configured to supply the address signal and the power supply voltage to the corresponding first to fourth radio wave reflecting devices Each of the first to fourth radio wave reflecting devices includes an intelligent reflecting surface including a plurality of patch electrodes arranged in a matrix in the first direction and the second direction, an electrode layer facing and spaced apart from the plurality of patch electrodes, and a liquid crystal layer provided between the plurality of patch electrodes and the electrode layer, a driver IC electrically connected to the plurality of patch electrodes and including an output signal generating unit and a timing pattern signal generating unit, a first side facing the first direction and arranged parallel to the second direction, and a second side arranged parallel to the first side. The timing pattern signal generating units included in each of the first to fourth radio wave reflecting devices are configured to generate a plurality of pattern signals including voltage values corresponding to each of the plurality of predetermined phase values using the address signal, the power supply voltage, and the pattern selection signal. The output signal generating units included in each of the first to fourth radio wave reflecting devices are configured to generate a plurality of output signals based on each of the plurality of pattern signals using the corresponding plurality of pattern signals, and to supply each of the plurality of output signals to the corresponding plurality of patch electrodes.

### BRIEF DESCRIPTION OF DRAWINGS

FIG. 1 is a functional block diagram showing a configuration of a radio wave reflecting system and a host according to a first embodiment of the present invention.

FIG. 2 is a functional block diagram showing a configuration of a radio wave reflecting system and a host according to the first embodiment of the present invention.

FIG. 3 is a diagram showing an example of parameters used in a radio wave reflecting system according to the first embodiment of the present invention.

FIG. 4 is a plan view showing a configuration of a radio wave reflecting system and a host according to the first embodiment of the present invention.

FIG. 5 is a plan view showing a reflector unit cell used in a radio wave reflecting device according to the first embodiment of the present invention.

FIG. 6 is a cross-sectional view showing a cut surface of a radio wave reflecting device according to the first embodiment of the present invention.

FIG. 7 is a diagram schematically showing that a traveling direction of a reflected wave is changed by a reflector according to the first embodiment of the present invention.

FIG. 8A is a cross-sectional view showing a cut surface of a radio wave reflecting system according to the first embodiment of the present invention.

FIG. 8B is a diagram illustrating a pattern signal of a radio wave reflecting system according to the first embodiment of the present invention.

FIG. 9A is a diagram showing a state in which a voltage is not supplied between a patch electrode and an electrode layer in a reflector unit cell according to the first embodiment of the present invention.

FIG. 9B is a diagram showing a state in which a voltage is supplied between a patch electrode and an electrode layer in a reflector unit cell according to the first embodiment of the present invention.

FIG. 10 is a functional block diagram showing a configuration of a radio wave reflecting system and a modification of a host according to the first embodiment of the present invention.

FIG. 11 shows a modification of a configuration of a radio wave reflecting device according to the first embodiment of the present invention

FIG. 12 is a functional block diagram showing a configuration of a radio wave reflecting system and a host according to a second embodiment of the present invention.

FIG. 13 is a functional block diagram showing a configuration of a radio wave reflecting system and a host according to the second embodiment of the present invention.

FIG. 14 is a functional block diagram showing a configuration of a radio wave reflecting system and a host according to the second embodiment of the present invention.

FIG. 15 is a functional block diagram showing a configuration of a radio wave reflecting system and a host according to a third embodiment of the present invention.

FIG. 16A is a functional block diagram showing a radio wave reflecting system according to the third embodiment of the present invention.

FIG. 16B is a functional block diagram showing a modification of a configuration of a radio wave reflecting system according to the third embodiment of the present invention.

### DESCRIPTION OF EMBODIMENTS

A radio wave reflecting device represented by a metasurface is controlled using, for example, an external device (for example, a host). For example, in the case where the radio wave reflecting device dynamically controls the reflection direction following a moving object including a portable information terminal, the radio wave reflecting device needs to receive a large number of signals, such as a high-frequency signal transmitted to each of the plurality of antenna elements, other signals for controlling the radio wave reflecting device, and a power supply. In addition, in the case where the radio wave reflecting device is installed to avoid a shield, the radio wave reflecting device may not be dynamically controlled. Therefore, the radio wave reflecting device is required to have a simple configuration such that, for example, a small number of signals is received and operated.

In view of such problems, an object of an embodiment of the present invention is to provide a radio wave reflecting system having a simple configuration.

Hereinafter, embodiments of the present invention will be described with reference to the drawings and the like. However, the present invention can be implemented in many different aspects, and should not be construed as being limited to the description of the embodiments exemplified below. In order to make the description clearer, the drawings may be schematically represented with respect to the width, thickness, shape, and the like of each part as compared with the actual embodiment, but the drawings are merely examples, and do not limit the interpretation of the present invention. Further, in the present specification and the drawings, elements similar to those described above with respect to the above-described figures are denoted by the same reference signs (or reference signs denoted by a, b, and the like) and detailed description thereof may be omitted as appropriate. Furthermore, the terms “first” and “second” with respect to the respective elements are convenient signs used to distinguish the respective elements, and do not have any further meaning unless otherwise specified.

In the present specification, when a member or region is “above (or below)” another member or region, without limitation, it includes the case where it is directly above (or below) the other member or region, but also the case where it is above (or below) the other member or region, i.e., the case where another component is included between above (or below) the other member or region.

In the present specification, a direction D1 intersects a direction D2, and a direction D3 intersects the direction D1 and the direction D2 (D1D2 plane). The direction D1 is referred to as a first direction, the direction D2 is referred to as a second direction, and the direction D3 is referred to as a third direction. For example, the direction D1, the direction D2, and the direction D3 correspond to a direction X (direction x), a direction Y (direction y), and a direction Z (direction z).

In the present specification, in the case where the terms “same” and “match” are used, the “same” and “match” may include errors within the scope of the design.

### First Embodiment

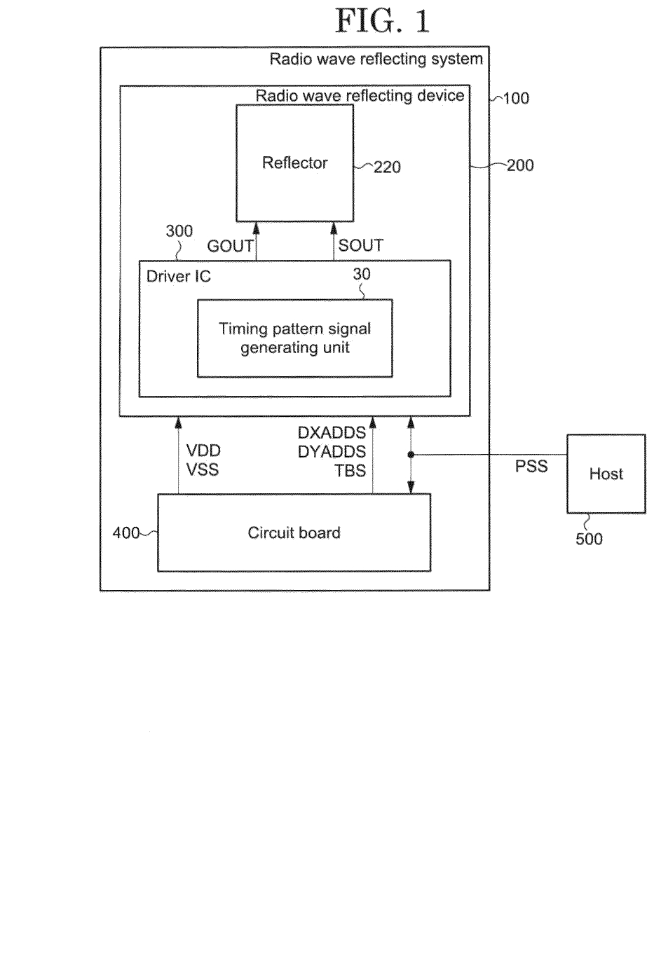

In the first embodiment, a radio wave reflecting system 100 including a radio wave reflecting device 200 capable of controlling the reflection of radio waves will be described with reference to FIG. 1 to FIG. 10.

### 1. Overview of Radio Wave Reflecting System 100

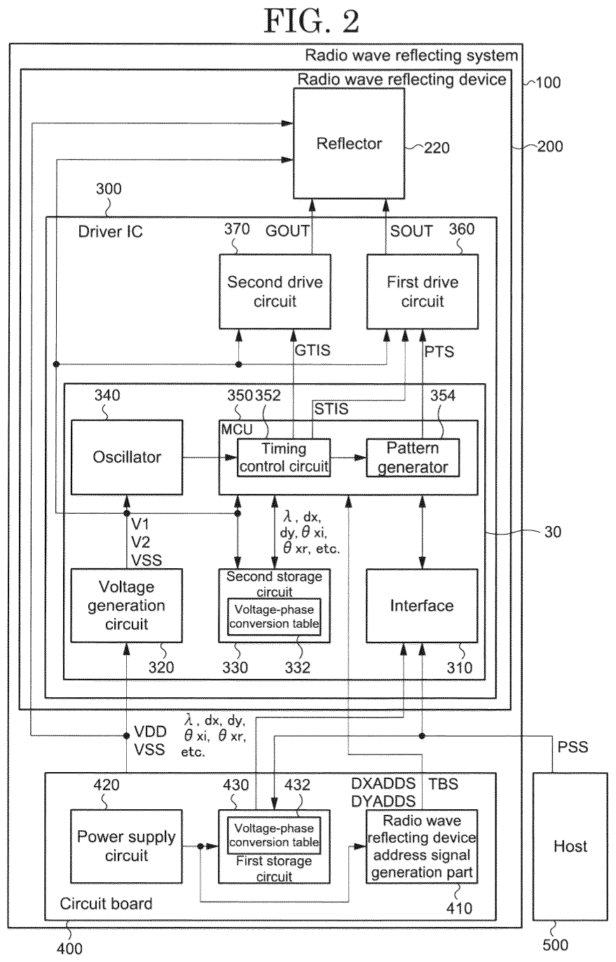

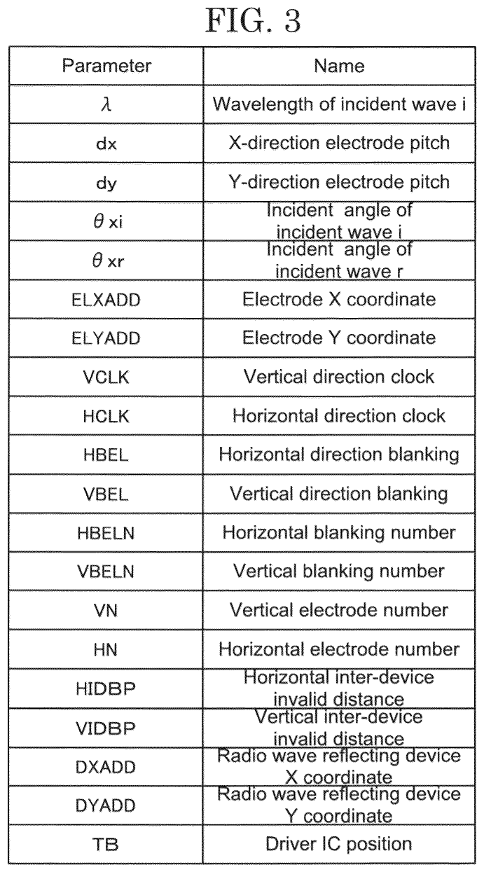

An overview of the radio wave reflecting system 100 will be described with reference to FIG. 1 to FIG. 3. FIG. 1 and FIG. 2 are functional block diagrams showing a configuration of the radio wave reflecting system 100 and a host. FIG. 3 is a diagram showing an example of parameters used in the radio wave reflecting system 100.

As shown in FIG. 1 and FIG. 2, the radio wave reflecting device 100 includes a two-axis reflection controllable radio wave reflecting device 200 and a circuit board 400. The radio wave reflecting device 200 includes a reflector 220 and a driver IC 300. The driver IC 300 includes a timing pattern signal generating unit 30.

The radio wave reflecting system 100 may receive a pattern selection signal PSS, a signal (a device X coordinate signal DXADDS, a device Y coordinate signal DYADDS) including coordinates indicating the position of the radio wave reflecting device 200, a signal (a driver position signal TBS) indicating the position where the driver IC 300 is arranged in the radio wave reflecting device 200, and a voltage (voltage VDD, voltage VSS), and the radio wave reflecting system can reflect an incident radio wave in a predetermined direction. That is, the radio wave reflecting system 100 is operable with a small number of signal inputs. Therefore, the radio wave reflecting device 200 can operate with a simple configuration. In the embodiments of the present invention, coordinates may be referred to as addresses, and coordinate signals may be referred to as address signals.

### [1-1. Reflector 220]

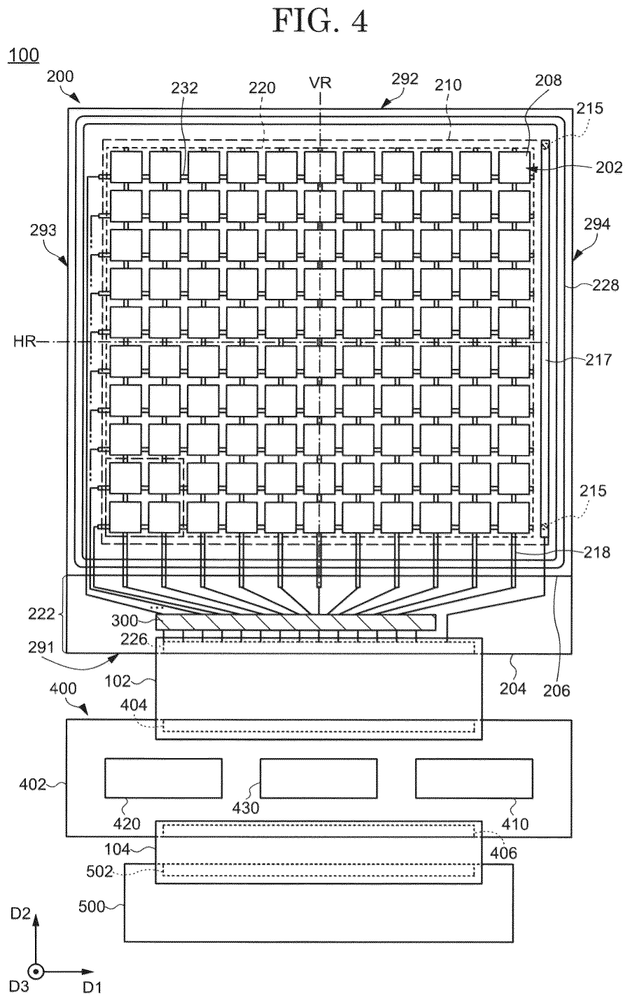

The reflector 220 has a function of reflecting radio waves in a predetermined direction. The reflector 220 includes a plurality of reflector unit cells 202 (see FIG. 4). Although details will be described later, a direction in which the reflector 220 reflects radio waves (the reflection direction of radio waves) is determined by the incident direction of the radio wave and the phases of each of the plurality of reflector unit cells 202. In the embodiments of the present invention, the phase may be referred to as a phase value. The reflector 220 may be referred to as a radio wave reflector (intelligent reflecting surface).

As shown in FIG. 1 or FIG. 2, the reflector 220 (the plurality of reflector unit cells 202) receives a first output signal SOUT and a second output signal GOUT from the driver IC 300. The first output signal SOUT and the second output signal GOUT are signals for driving the reflector 220 (the plurality of reflector unit cells 202). In addition, the reflector 220 may receive the voltage VDD, the voltage VSS, and the like from the circuit board 400. The voltage VDD and the voltage VSS are voltages for driving the radio wave reflecting device 200.

The first output signal SOUT and the second output signal GOUT include information on coordinates indicating respective positions of the plurality of reflector unit cells 202 (see FIG. 3, an electrode X coordinate ELXADD and an electrode Y coordinate ELYADD), information on operation timing for driving each of the plurality of reflector unit cells 202 (see FIG. 2, a gate timing adjustment signal GTIS and a source timing adjustment signal STIS), and a plurality of voltage values for driving each of the plurality of reflector unit cells 202. The plurality of voltage values correspond to the phases of each of the plurality of reflector unit cells 202. In the embodiments of the present invention, the information may be referred to as data.

### [1-2. Configuration of Driver IC 300]

The driver IC 300 has a function of generating the first output signal SOUT and the second output signal GOUT for driving the reflector 220 (the plurality of reflector unit cells 202). In addition, the driver IC 300 has a function of generating a pattern signal PTS and the timing adjustment signals for reflecting radio waves in a predetermined direction.

The pattern signal PTS is a signal for determining the reflection direction of the reflector 220 according to the incident direction of radio waves, and includes the electrode X coordinate ELXADD, the electrode Y coordinate ELYADD, and the plurality of voltage values for driving each of the plurality of reflector unit cells 202. The electrode X coordinate ELXADD and the electrode Y coordinate signal ELYADD indicate the position where the plurality of reflector unit cells 202 is arranged in the reflector 220.

For example, the timing adjustment signal includes the gate timing adjustment signal GTIS for controlling the timing in the gate direction of the plurality of reflector unit cells 202, and the source timing adjustment signal STIS for controlling the timing in the source direction of the plurality of reflector unit cells 202.

As shown in FIG. 1 or FIG. 2, the driver IC 300 includes a first drive circuit 360 and a second drive circuit 370. In addition, as described above, the driver IC 300 includes the timing pattern signal generating unit 30. The timing pattern signal generating unit 30 includes an interface 310, a voltage generation circuit 320, a second storage circuit 330, an oscillator 340, and an MCU (Micro Controller Unit) 350. The first drive circuit 360 and the second drive circuit 370 may be collectively referred to as an output circuit.

The driver IC 300 receives the pattern selection signal PSS from a host 500 and receives the device X coordinate signal DXADDS, the device Y coordinate signal DYADDS, the driver position signal TBS, the voltage

VDD, the voltage VSS, and the like from the circuit board 400.

More specifically, the interface 310 receives the pattern selection PSS from the host 500. The MCU 350 receives the device X coordinate signal DXADDS, the device Y coordinate signal DYADDS, and the driver position signal TBS from the circuit board 400. The voltage generation circuit 320 receives the voltage VDD and the voltage VSS from the circuit board 400.

The pattern selection signal PSS is a signal for selecting a plurality of parameters. The plurality of parameters is required to generate the pattern signal PTS and the timing adjustment signal. The device X coordinate signal DXADDS and the device Y coordinate signal DYADDS are signals including coordinates indicating the position of the radio wave reflecting device 200, and the driver position signal TBS is a signal indicating the position where the driver IC 300 is arranged in the radio wave reflecting device 200.

In addition, the driver IC 300 generates the pattern signal PTS using the timing pattern signal generating unit 30 based on the pattern selection signal PSS, the plurality of parameters selected by the pattern selection signal PSS, the device X coordinate signal DXADDS, the device Y coordinate signal DYADDS, the driver position signal TBS, the voltage VDD, and the voltage VSS.

Further, the driver IC 300 (the timing pattern signal generating unit 30) generates the first output signal SOUT and the second output signal GOUT based on the pattern signal PTS, and transmits the first output signal

SOUT and the second output signal GOUT to the reflector 220 (the plurality of reflector unit cells 202).

More specifically, the pattern signal PTS, the first output signal SOUT, and the second output signal GOUT are generated as follows.

For example, the voltage generation circuit 320 generates a voltage V1 and a voltage V2 using the voltage VDD and the voltage VSS, and transmits the voltage V1 and the voltage V2 to each circuit in the driver IC 300. The voltage V1 and the voltage V2 are voltages indicating the voltage values between the voltage VDD and the voltage VSS, and are voltages for driving the driver IC 300 and the radio wave reflecting device 200. In addition, the voltage generated by the voltage generation circuit 320 is not limited to the voltage V1 and the voltage V2, and a plurality of voltages including the voltage V1 and the voltage V2 may be generated. The type (number) of voltages generated by the voltage generation circuit 320 may be appropriately selected according to the application, specification, and the like of the radio wave reflecting system 100.

The second storage circuit 330 includes a voltage-phase conversion table 322. The voltage-phase conversion table 322 is a table in which the respective phases of the plurality of reflector unit cells 202 are associated with the voltage values corresponding to the respective phases. The radio wave reflecting system 100 can convert the respective phases of the plurality of reflector unit cells 202 into the plurality of voltage values for driving each of the plurality of reflector unit cells 202 by using the voltage-phase conversion table 322.

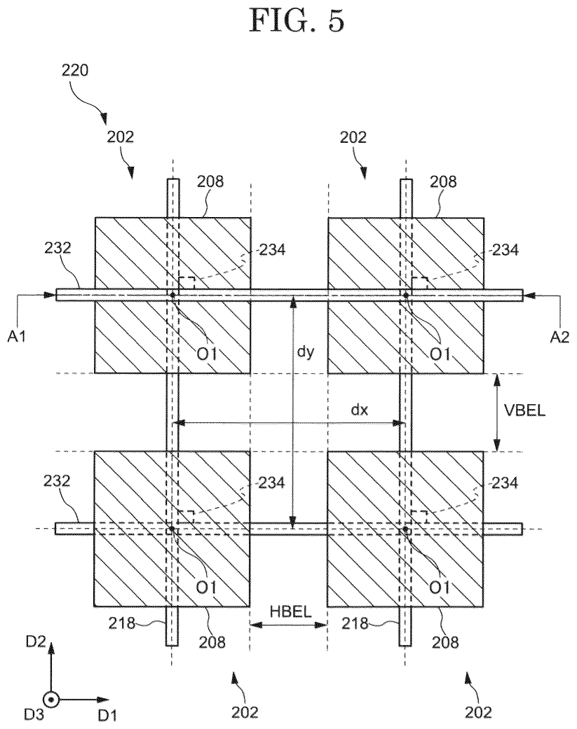

In addition, the second storage circuit 330 stores the plurality of parameters. Although details will be described later, for example, the plurality of parameters includes a wavelength λ of an incident wave i, an X-direction electrode pitch dx indicating a distance in the direction D1 between two reflector unit cells 202 (two patch electrodes 108 (see FIG. 5)), a Y-direction electrode pitch dy indicating a distance in the direction D2 between two reflector unit cells 202 (the two patch electrodes 108 (see FIG. 5)), an incident angle θxi of the incident wave i, a reflection angle θxr of a reflected wave r, and the like.

For example, the oscillator 340 uses the voltage V1, the voltage V2, and the voltage VSS to generate a clock HCLK serving as a reference in the horizontal direction (the direction D1 (direction X)), a clock VCLK serving as a reference in the vertical direction (the direction D2 (direction Y)), and the like, and transmits the clock HCLK, the clock VCLK, and the like to the MCU 350.

The MCU 350 includes a timing control circuit 352 and a pattern generator 354. The voltage V1, the voltage V2, and the voltage VSS are supplied to the MCU 350. Based on the pattern selection signal PSS, the MCU 350 reads, from the second storage circuit 330, the plurality of parameters including a phase of each of the plurality of reflector unit cells 202, the plurality of voltage values for driving each of the plurality of reflector unit cells 202, the X-direction electrode pitch dx, the Y-direction electrode pitch dy, the incidence angle θxi of the incident wave i, the reflection angle θxr of the reflected wave r, and the like, and receives the plurality of parameters. In addition, the MCU 350 may receive the pattern selection signal PSS and a hardware reset signal from the host 500, read the plurality of parameters for driving the reflector 220 (the plurality of reflector unit cells 202) from the second storage circuit 330 based on the pattern selection signal PSS and the hardware reset signal, and receive the plurality of parameters.

In addition, the MCU 350 generates the gate timing adjustment signal GTIS and the source timing adjustment signal STIS based on the plurality of parameters, the clock HCLK, the clock VCLK, the pattern selection signal PSS, the device X coordinate signal DXADDS, the device Y coordinate signal DYADDS, and the driver position signal TBS using the timing control circuit 352. Further, the MCU 350 generates the pattern signal PTS using the pattern generator 354 based on the plurality of parameters, the clock HCLK, the clock VCLK, the pattern selection signal PSS, the device X coordinate signal DXADDS, the device Y coordinate signal DYADDS, and the driver position signal TBS.

Further, the voltage V1, the voltage V2, and the voltage VSS are supplied to the first drive circuit 360 and the second drive circuit 370. The first drive circuit 360 receives the pattern signal PTS from the timing control circuit 352, receives the source timing adjustment signal STIS from the pattern generator 354, and generates the first output signal SOUT and the second output signal GOUT. In addition, the second drive circuit 370 receives the source timing adjustment signal STIS from the pattern generator 354 and generates the second output signal GOUT. The first drive circuit 360 and the second drive circuit 370 transmit the first output signal SOUT and the second output signal GOUT to the reflector 220 (the plurality of reflector unit cells 202). Further, the second drive circuit 370 may receive the pattern signal PTS from the timing control circuit 352.

For example, the host 500 transmits the pattern selection signal PSS to the circuit board and the radio wave reflecting device 200. For example, a communication interface such as an I²C (Inter-Integrated Circuit) or an SPI (Serial Peripheral Interface) is used to transmit the pattern selection signal PSS.

As described above, the radio wave reflecting device 200 operates using a signal including coordinates indicating the position of the radio wave reflecting device 200, a signal indicating the position where the driver IC 300 is arranged in the radio wave reflecting device 200, and a voltage. Therefore, the radio wave reflecting device 200 can operate with a simple configuration.

### [1-3. Configuration of Circuit Board 400]

The circuit board 400 has a function of receiving the pattern selection signal PSS from the host 500 and generating at least the device X coordinate signal DXADDS, the device Y coordinate signal DYADDS, and the driver position signal TBS based on the pattern selection signal PSS. In addition, the circuit board 400 has a function of supplying the voltage VDD and the voltage VSS to the respective circuits.

The circuit board 400 includes a power supply circuit 420, a radio wave reflecting device address signal generation part 410, and a first storage circuit 430. The circuit board 400 is electrically connected to the radio wave reflecting device 200 and the host 500.

The power supply circuit 420 generates voltages for driving the radio wave reflecting device address signal generation part 410, the first storage circuit 430, the driver IC 300, and the reflector 220, and supplies the generated voltages to the radio wave reflecting device address signal generation part 410, the first storage circuit 430, the driver IC 300, and the reflector 220. The power supply circuit 420 is electrically connected to the radio wave reflecting device address signal generation part 410 and the first storage circuit 430.

For example, the power supply circuit 420 generates the voltage VDD that is greater than the reference voltage VSS and supplies the voltage VSS and the voltage VDD to the radio wave reflecting device address signal generation part 410, the first storage circuit 430, the driver IC 300, and the reflector 220. In addition, the voltage generated by the power supply circuit 420 is not limited to the voltage VDD, and a plurality of voltages including the voltage VDD may be generated. The type (number) of voltages generated by the power supply circuit 420 may be appropriately selected according to the application, specification, and the like of the radio wave reflecting device 100.

The radio wave reflecting device address signal generation part 410 generates the device X coordinate signal DXADDS, the device Y coordinate signal DYADDS, and the driver position signal TBS, and transmits the device X coordinate signal DXADDS, the device Y coordinate signal DYADDS, and the driver position signal TBS to the radio wave reflecting device 200 (the MCU 350).

The first storage circuit 430 includes a voltage-phase conversion table 432. The first storage circuit 430 and the voltage-phase conversion table 432 have functions and configurations similar to those of the second storage circuit 330 and the voltage-phase conversion table 322. Descriptions of the functions and configurations similar to those of the second storage circuit 330 and the voltage-phase conversion table 322 will be omitted here. For example, the host 500 may read, from the first storage circuit 430, the plurality of parameters including the respective phases of the plurality of reflector unit cells 202, the plurality of voltage values for driving each of the plurality of reflector unit cells 202, the X-direction electrode pitch dx, the Y-direction electrode pitch dy, the incidence angle θxi of the incident wave i, the reflection angle θxr of the reflected wave r, and the like, based on the pattern selection signal PSS, and may receive the plurality of parameters. In addition, the host 500 may transmit the plurality of parameters to the MCU 350 via the interface 310.

Further, the circuit board 400 may receive the pattern selection signal PSS and a hardware reset signal from the host 500, read the plurality of parameters for driving the reflector 220 (the plurality of reflector unit cells 202) from the first storage circuit 430 based on the pattern selection signal PSS and the hardware reset signal, and receive the plurality of parameters.

In addition, the radio wave reflecting system 100 may include at least one of the first storage circuit 430 and the second storage circuit 330. In the case where the radio wave reflecting system 100 includes both the first storage circuit 430 and the second storage circuit 330, the radio wave reflecting system 100 may receive, for example, a signal from the host 500 that disables one of the first storage circuit 430 and the second storage circuit 330, and not use one of the first storage circuit 430 and the second storage circuit 330.

### [1-4. Plurality of Parameters]

The first storage circuit 430 and the second storage circuit 330 include the plurality of parameters described in FIG. 3. For example, the plurality of parameters includes the wavelength λ of the incident wave i, the X-direction electrode pitch dx, the Y-direction electrode pitch dy, the incident angle θxi of the incident wave i, the reflection angle θxr of the reflected wave r, the electrode X-coordinate ELXADD, the electrode Y-coordinate ELYADD, the clock HCLK, the clock VCLK, a horizontal electrode blanking number HBELN, a vertical electrode blanking number VBELN, a horizontal electrode number HN, and a vertical electrode number VN.

The horizontal electrode blanking number HBELN indicates the number of gaps (blanking) between the patch electrodes 108 in the direction D1, the vertical electrode blanking number VBELN indicates the number of gaps (blanking) between the patch electrodes 108 in the direction D2, and the horizontal electrode number HN and the vertical electrode number VN indicate the number of patch electrodes 108 in the direction D1 and the direction D2.

In addition, the plurality of parameters is not limited to the example shown in FIG. 3, and may be any parameters for driving the reflector 220 (the plurality of reflector unit cells 202). The plurality of parameters may be appropriately selected according to the use, specification, and the like of the radio wave reflecting system 100.

### 2. Configuration of Radio Wave Reflecting System 100

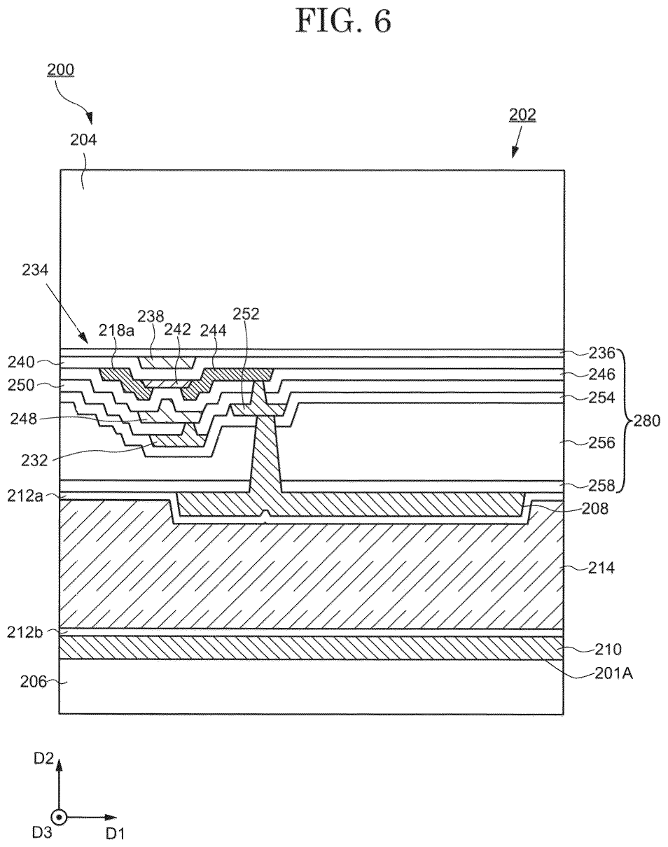

The configuration of the radio wave reflecting system 100 will be described with reference to FIG. 4 to FIG. 6. FIG. 4 is a plan view showing the configuration of the radio wave reflecting device 100 and the host. FIG. 5 is a plan view showing the reflector unit cell 202 used in the radio wave reflecting device 200 and an enlarged view of the arrangement of a patch electrode 208 and a first wiring 218. FIG. 6 is a cross-sectional view showing a cut surface of the radio wave reflecting device 200 according to the first embodiment. The description of configurations that are the same as or similar to those in FIG. 1 to FIG. 3 will be omitted here.

As shown in FIG. 4, the radio wave reflecting system 100 includes the radio wave reflecting device 200 and the circuit board 400 described in “1. Overview of Radio Wave Reflecting System 100” to “1-4. Plurality of Parameters”. The radio wave reflecting device 100 includes a flexible printed circuit board (FPC) 102 and a flexible printed circuit board (FPC) 104. The FPC 102 is attached to a terminal part 226 of the radio wave reflecting device 200 and a terminal part 404 of the circuit board 400, and connects the radio wave reflecting device 200 and the circuit board 400. The FPC 104 is attached to a terminal part 406 of the circuit board 400 and a terminal part 502 of the host 500, and connects the circuit board 400 and the host 500.

The radio wave reflecting device 200, the circuit board 400, and the host 500 are electrically connected by the configuration described above.

As a result, the host 500 can transmit the pattern selection signal PSS to the circuit board 400 via the FPC 104, and can transmit the pattern selection signal PSS and the plurality of parameters to the radio wave reflecting device 200 via the FPC 102 and the FPC 104. In addition, the circuit board 400 can supply the voltage VDD and the voltage VSS to the radio wave reflecting device 200 via the FPC 102 and transmit the device X coordinate signal DXADDS, the device Y coordinate signal DYADDS, and the driver position signal TBS.

The radio wave reflecting device 200 includes a dielectric substrate 204, a counter substrate 206, and a peripheral region 222. The radio wave reflecting device 200 (the dielectric substrate 204) has a first side 291 along the direction D1, a third side 293 intersecting the first side 291 along the direction D2, a second side 292 intersecting the third side 293 and facing parallel to the first side 291, and a fourth side 294 intersecting the first side 291 and the second side 292 and facing parallel to the third side 293. The counter substrate 206 overlaps the dielectric substrate 204 and the counter substrate 206 is bonded to the dielectric substrate 204 using a sealant 228. Although details will be described later, a region surrounded by the counter substrate 206, the dielectric substrate 204, and the sealant 228 includes a liquid crystal layer 214. In addition, the dielectric substrate 204 may be referred to as a first substrate, and the counter substrate 206 may be referred to as a second substrate. For example, the driver IC 300 shown in FIG. 4 is arranged on the first side. The arrangement of the driver IC 300 is not limited to the arrangement shown in FIG. 4, and the driver IC 300 may be arranged on the second side.

A region of the dielectric substrate 204 except where the dielectric substrate 204 and the counter substrate 206 overlap is called the peripheral region 222. The peripheral region 222 includes the driver IC 300 and the terminal part 226 arranged on the dielectric substrate 204. The terminal part 226 is a region that connects to an external circuit (e.g., the circuit board 400). As described above, the FPC 102 is attached to the terminal part 226, and the voltage VDD, the voltage VSS, the device X coordinate signal DXADDS, the device Y coordinate signal DYADDS, and the driver position signal TBS are supplied from the circuit board 400 to the terminal part 226.

A plurality of patch electrodes 208 is arranged on the dielectric substrate 204 in a matrix in the direction D1 and the direction D2.

A plurality of first wirings 218 arranged in the dielectric substrate 204 extend in the Y-direction, extend in the peripheral region 222, and is connected to the driver IC 300. For example, a plurality of second wirings 232 arranged in the dielectric substrate 204 extend in the direction D1, extend in the direction D2 on the outer side of an electrode layer 210, and is connected to the driver IC 300. The second output signal GOUT corresponding to each of the plurality of first wirings 218 is supplied from the driver IC 300 to the plurality of first wirings 218. The first output signal SOUT corresponding to each of the plurality of second wirings 232 is supplied from the driver IC 300 to the plurality of second wirings 232.

The electrode layer 210 arranged on the counter substrate 206 extends in the direction D1 and the direction D2 and is electrically connected via a connection portion 215 to a ground wiring 217 arranged on the dielectric substrate 204. The ground wiring 217 extends to the peripheral region 222 and is connected to the terminal part 226. A ground voltage is supplied from the terminal part 226 to the electrode layer 210. For example, the ground voltage is the voltage VSS.

The radio wave reflecting device 200 can control the traveling direction of the reflected wave of the radio wave incident on the reflector 220 in the left-right direction of the drawing around a reflection axis VR parallel to the direction D2 (direction Y) and can also control the traveling direction of the reflected wave in the up-down direction of the drawing around a reflection axis HR parallel to the direction D1 (direction X). That is, the radio wave reflecting device 200 includes the reflection axis VR parallel to the direction D2 (direction Y) and a reflection axis VH parallel to the direction D1 (direction X), and can control the reflection angle in a direction with the reflection axis VR as the rotating axis and a direction with the reflection axis HR as the rotating axis.

The circuit board 400 includes a printed circuit board 402. The power supply circuit 420, the radio wave reflecting device address signal generation part 410, and the first storage circuit 430 described in “1-3. Configuration of Circuit Board 400” are mounted on the printed circuit board 402.

FIG. 5 is an enlarged view of the arrangement of the patch electrode 208 and the first wiring 218. A switching element 234 is provided on the patch electrode 208. The switching (on and off) of the switching element 234 is controlled by the output signal GOUT transmitted to the second wiring 232. In response to the output signal GOUT, the patch electrode 208 whose switching element 234 is turned on is electrically connected to the first wiring 218, and the output signal SOUT is transmitted. For example, the switching element 234 is formed of a thin film transistor. According to this configuration, the plurality of patch electrodes 208 arranged in the direction D1 can be selected for each row, and the output signal SOUT having different voltage levels can be transmitted to each row.

A distance between a center O1 of the two adjacent patch electrodes 208 along the direction D1 is the X-direction electrode pitch dx, and a distance between the center O1 of the two adjacent patch electrodes 208 along the direction D2 is the Y-direction electrode pitch dy. A horizontal blanking HBEL is provided between two adjacent patch electrodes 208 along the direction D1, and a vertical blanking VBEL is provided between two adjacent patch electrodes 208 along the direction D2. In addition, the number of the horizontal blanking HBEL is the horizontal electrode blanking number HBELN and the number of the vertical blanking VBEL is the vertical electrode blanking number VBELN.

In addition, the X-direction electrode pitch dx, the Y-direction electrode pitch dy, the horizontal blanking HBEL, the vertical blanking VBEL, the horizontal blanking number HBELN, and the vertical blanking number VBELN are the plurality of parameters (see FIG. 3) stored in the first storage circuit 430 and the second storage circuit 330.

FIG. 6 is a diagram showing an example of a cross-sectional structure of the radio wave reflecting device according to the first embodiment of the present invention, and a diagram showing an example of a cross-sectional structure of the reflector unit cell 202 in which the switching element 234 is connected to the patch electrode 208. For example, the reflector unit cell 202 includes a portion of the dielectric substrate 204, a portion of an array layer 280 including the switching element 234, one patch electrode 208 electrically connected to the switching element 234, a portion of a first alignment film 212a, a portion of the liquid crystal layer 214, a portion of a second alignment film 212b, a portion of the electrode layer 210, and a portion of the counter substrate 206. The switching element 234 is provided on the dielectric substrate 204. The switching element 234 is a transistor. The switching element 234 includes a structure in which a first gate electrode 238, a second gate insulating layer 246, a semiconductor layer 242, and a second gate electrode 248 are stacked. An undercoat layer 236 may be provided between the first gate electrode 238 and the dielectric substrate 204. The first wiring 218 is provided between a first gate insulating layer 240 and the second gate insulating layer 246. The first wiring 218 is provided in contact with the semiconductor layer 242. In addition, a first connection wiring 244 is provided on the same conductive layer as the conductive layer forming the first wiring 218. The first connection wiring 244 is provided in contact with the semiconductor layer 242. The connection structure of the first wiring 218 and the first connection wiring 244 with respect to the semiconductor layer 242 shows a structure in which one wiring is connected to a source of the transistor and the other wiring is connected to a drain.

A first interlayer insulating layer 250 is provided to cover the switching element 234. The second wiring 232 is provided on the first interlayer insulating layer 250. The second wiring 232 is connected to the second gate electrode 248 via a contact hole formed in the first interlayer insulating layer 250. In addition, although not shown, the first gate electrode 238 and the second gate electrode 248 are electrically connected in a region that does not overlap the semiconductor layer 242. A second connection wiring 252 is provided on the first interlayer insulating layer 250 with the same conductive layer as the second wiring 232. The second connection wiring 252 is connected to the first connection wiring 244 via the contact hole formed in the first interlayer insulating layer 250.

A second interlayer insulating layer 254 is provided to cover the second wiring 232 and the second connection wiring 252. Further, a planarization layer 256 is provided to fill a step caused by the formation of the switching element 234. The step of the switching element 234 can be filled by providing the planarization layer 256, so that the surface of the planarization layer 256 becomes flat. Therefore, the patch electrode 208 can be formed on the flat surface (surface) of the planarization layer 256 without being affected by the step of the switching element 234. A passivation layer 258 is provided on the flat surface of the planarization layer 256. In the radio wave reflecting system 100, the array layer 280 includes, for example, the undercoat layer 236, a conductive layer including the first gate electrode 238, the first gate insulating layer 240, the semiconductor layer 242, a conductive layer including the first connection wiring 244, the second gate insulating layer 246, a conductive layer including the second gate electrode 248, the first interlayer insulating layer 250, a conductive layer including the second connection wiring 252, the second interlayer insulating layer 254, the planarization layer 256, and the passivation layer 258. The array layer 280 may include a conductive layer forming the patch electrode 208 provided in a contact hole that penetrates the passivation layer 258, the planarization layer 256, and the second interlayer insulating layer 254.

The patch electrode 208 is provided on the passivation layer 258. The patch electrode 208 is connected to the second connection wiring 252 via a contact hole that penetrates the passivation layer 258, the planarization layer 256, and the second interlayer insulating layer 254. The first alignment film 212a is provided on the patch electrode 208.

The electrode layer 210 is provided on a first main surface 201A of the counter substrate 206. The second alignment film 212b is provided on the electrode layer 210. The surface of the dielectric substrate 204 on which the switching element 234 and the patch electrode 208 are provided is arranged to face the first main surface 201A of the counter substrate 206. The liquid crystal layer 214 is provided between the first alignment film 212a and the second alignment film 212b.

Each layer formed on the dielectric substrate 204 is formed using the following materials. For example, the undercoat layer 236 is formed of a silicon oxide film. For example, the first gate insulating layer 240 and the second gate insulating layer 246 are formed of a silicon oxide film or a stacked structure of a silicon oxide film and a silicon nitride film. The semiconductor layer is formed of a silicon semiconductor such as amorphous silicon or polycrystalline silicon, or an oxide semiconductor including a metal oxide such as indium oxide, zinc oxide, or gallium oxide. For example, the first gate electrode 238 and the second gate electrode 248 may be composed of molybdenum (Mo), tungsten (W), or an alloy thereof. The first wiring 218, the second wiring 232, the first connection wiring 244, and the second connection wiring 252 are formed using a metal material such as titanium (Ti), aluminum (Al), or molybdenum (Mo). For example, they may be composed of a stacked structure of titanium (Ti)/aluminum (Al)/titanium (Ti), or a stacked structure of molybdenum (Mo)/aluminum (Al)/molybdenum (Mo). The planarization layer 256 is formed of a resin material such as acrylic or polyimide. The passivation layer 258 is formed of, for example, a silicon nitride film. The patch electrode 208 and the electrode layer 210 are formed of a metal film such as aluminum (Al) or copper (Cu), or a transparent conductive film such as indium tin oxide (ITO).

The second wiring 232 is connected to the gate of the transistor used as the switching element 234, the first wiring 218 is connected to one of the source and the drain of the transistor, and the patch electrode 208 is connected to the other of the source and the drain. As a result, a predetermined patch electrode 208 can be selected from the plurality of patch electrodes 208 arranged in a matrix, and the output signal SOUT can be transmitted. In addition, by providing the switching element 234 on the individual patch electrodes 208 in the reflector 220, the output signal SOUT can be transmitted for each of the patch electrodes 208 arranged in a row parallel to the direction D1 or for each of the patch electrodes 208 arranged in a row parallel to the direction D2.

### 3. Overview of Operation of Reflector 220 (Reflector Unit Cell 202)

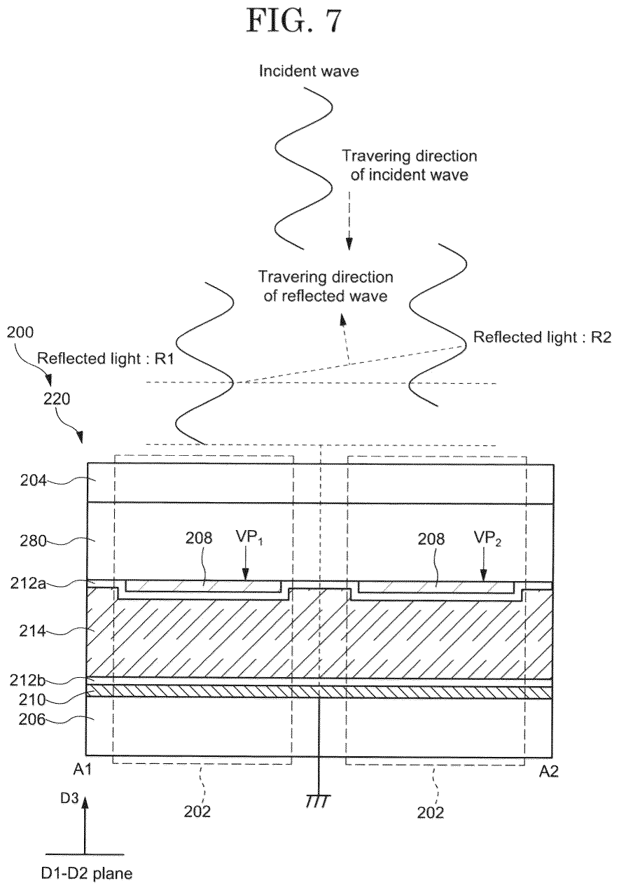

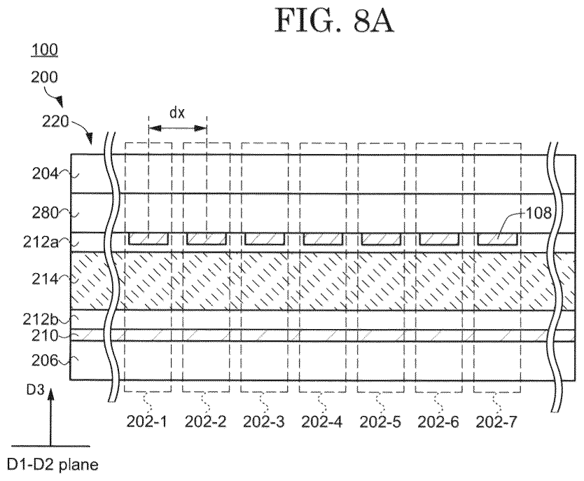

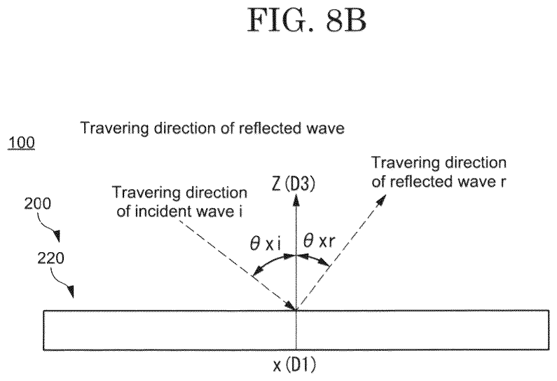

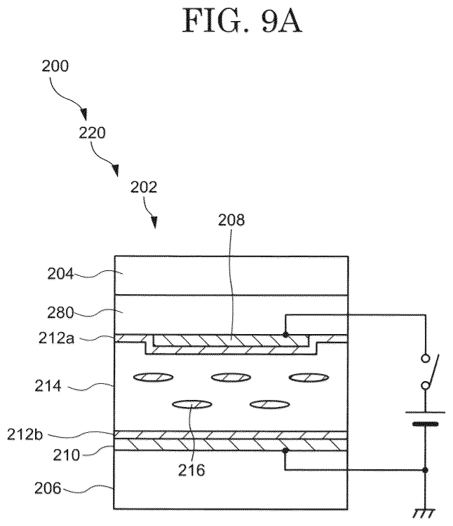

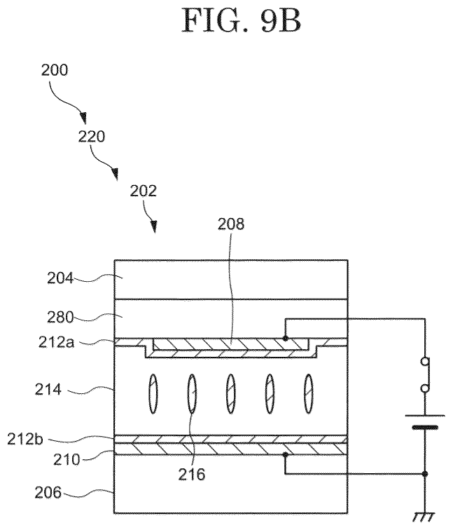

An overview of an operation of the reflector 220 (reflector unit cell 202) will be described with reference to FIG. 7 to FIG. 8B. FIG. 7 is a diagram schematically showing that the traveling direction of the reflected wave is changed by the reflector 220 (reflector unit cell 202), and is a diagram schematically showing a cross section cut along a line A1-A2 shown in FIG. 5. FIG. 8A is a schematic cross-sectional view showing a cut surface of the radio wave reflecting system 100, and FIG. 8B is a diagram for explaining the pattern signal PTS of the radio wave reflecting system 100. FIG. 9A is a diagram schematically showing a state in which a voltage is not supplied between the patch electrode 208 and the electrode layer 210 in the reflector unit cell 202. FIG. 9B is a diagram showing a state in which a voltage is supplied to the reflector unit cell 202 between the patch electrode 108 and the electrode layer 210. The description of configurations that are the same as or similar to those in FIG. 1 to FIG. 6 will be omitted here.

The frequency bands of the radio waves reflected by the reflector 220 (reflector unit cell 202) are a very high frequency (VHF) band, an ultra-high frequency (UHF) band, a microwave (SHF: Super High Frequency) band, a sub-millimeter wave (THF: Tremendously high frequency) band, and a millimeter wave (EHF: Extra High Frequency) band. In addition, the millimeter wave refers to the frequency band between 30 GHz to 300 GHz. Further, the frequency band of the fifth-generation communication standard called 5G includes the 26 GHz to 29 GHz bands, and frequencies above 26 GHz may be collectively referred to as millimeter waves.

The radio wave reflecting device 200 reflects the radio wave in the traveling direction of the reflected wave with respect to the traveling direction of the incident wave. For example, the radio wave reflected by the radio wave reflecting device 200 is a radio wave corresponding to the 5G standard communication.

As shown in FIG. 7, an arbitrary reflector unit cell 202 and the reflector unit cell 202 adjacent to the arbitrary reflector unit cell 202 are adjacent in the direction D1. An arbitrary patch electrode 208 and the patch electrode 108 adjacent to the arbitrary patch electrode 208 in the direction D2 are connected to different first wirings 218 (see FIG. 5).

In the case where a radio wave is incident on the arbitrary reflector unit cell 202 and the reflector unit cell 202 adjacent to the arbitrary reflector unit cell 202 in the same phase, different output signals SOUT (voltage VP₁≠voltage VP₂) are transmitted to the arbitrary reflector unit cell 202 and the reflector unit cell 202 adjacent to the arbitrary reflector unit cell 202, so that a change in phase of the reflected wave by the arbitrary reflector unit cell 202 is greater than a change in phase of the reflected wave by the reflector unit cell 202 adjacent to the arbitrary reflector unit cell 202. Unlike the phase of a reflected wave R1 reflected by the arbitrary reflector unit cell 202 and the phase of a reflected wave R2 reflected by the reflector unit cell 202 adjacent to the arbitrary reflector unit cell 202, the traveling direction of the reflected wave apparently changes in the oblique direction. For example, in the example shown in FIG. 7, the phase of the reflected wave R2 leads the phase of the reflected wave R1.

For example, the output signal SOUT for controlling the alignment of liquid crystal molecules 216 of the liquid crystal layer 214 is transmitted to the patch electrode 208. For example, the output signal SOUT is a signal of a DC voltage or a polarity-inverted signal in which a positive DC voltage and a negative DC voltage are alternately inverted. For example, the voltage VSS, the ground voltage, or an intermediate-level voltage of the polarity-inverted signal is applied to the electrode layer 210. When the output signal SOUT is transmitted to the patch electrode 208, the alignment state of the liquid crystal molecules 216 included in the liquid crystal layer 214 changes.

For example, the voltage VSS, the ground voltage, or the intermediate-level voltage of the polarity-inverted signal may be the ground voltage (GND voltage) or a voltage of 0 V.

The reflector unit cell 202 can change the dielectric constant of the liquid crystal layer 214 by changing the alignment state of the liquid crystal molecules 216. As a result, when the radio wave reflecting device 200 (reflector 220) reflects the radio wave, the phase of the reflected wave can be delayed.

The alignment state of the liquid crystal molecules 216 of the liquid crystal layer 214 changes depending on the output signal SOUT transmitted to the patch electrode 208, but hardly follows the frequency of the radio wave incident on the patch electrode 208. Therefore, the reflector unit cell 202 can control the phase of the reflected radio wave without being affected by the incident radio wave.

Each of the plurality of reflector unit cells 202 of the radio wave reflecting system 100 is represented as a reflector unit cell 202-n (n is a positive integer). For example, in the case where the reflector unit cell 202 is seven (i.e., when n=7), as shown in FIG. 8A, each of the plurality of reflector unit cells 202 is represented by a reflector unit cell 202-1, a reflector unit cell 202-2, . . . and a reflector unit cell 202-7.

In addition, as shown in FIG. 8B, the incident wave i travels and is incident on the reflector 220 at the incident angle θxi, and the reflected wave r travels and is reflected from the reflector 220 at the reflection angle θxr. In this case, the wavelength of the incident wave i is the wavelength λ.

As shown in FIG. 8A, for example, in the case where the reflector unit cells 202-1 to 202-7 are arranged in the direction D1 (D1-D2 plane) at the X-direction electrode pitch dx, a phase Ad at which the incident wave i is reflected by the reflected wave r is calculated using the following Equations (1) and (2).

$$ΔΦ = 2 π \times \frac{dx}{λ} \times ( sin θ xi - sin θ xr ) \qquad ( 1 )$$

$${Φ}_{n} = Δ {Φ}_{n - 1} \qquad ( 2 )$$

Further, in this case, a phase Φ₁ of the reflector unit cell 202-1 is calculated by Equation (3) below. For example, the voltage corresponding to the phase Φ₁ is the voltage VP₁.

$${Φ}_{1} = Δ {Φ}_{0} = 0 \qquad ( 3 )$$

Similar to the reflector unit cell 202-1, a phase Φ₂ of the reflector unit cell 202-2 is calculated by Equation (4) below. For example, the voltage corresponding to the phase Φ₂ is the voltage VP₂.

$${Φ}_{2} = Δ {Φ}_{1} \qquad ( 4 )$$

The phase of each unit cell after the reflector unit cell 202-3 is also calculated using Equations (1) and (2) similar to the reflector unit cells 202-1 and 202-2. In addition, for example, the voltages corresponding to a phase Φ₃ to a phase Φ₇ are a voltage VP₃ to a voltage VP₇.

For example, the pattern signal PTS of the reflector 220 including the reflector unit cells 202-1 to 202-7 is a signal including the voltage VP₁ to the voltage VP₇ satisfying Equation (3) when the phases of the reflector unit cells 202-1 to 202-7 are Equations (1) and (2) (n=1 to 7). For example, the voltage VP₁ to the voltage VP₇ may be generated using the voltage generation circuit 320 and may be generated using the power supply circuit 420. In addition, the voltage VP₁ to the voltage VP₇ may be stored in the first storage circuit 430 and may be stored in the second storage circuit 330.

FIG. 9A shows a state in which no voltage is applied between the patch electrode 208 and the electrode layer 210 (referred to as a “first state”). FIG. 9A shows that the first alignment film 212a and the second alignment film 212b are horizontal alignment films. The long axis of the liquid crystal molecules 216 in the first state is aligned horizontally with respect to the surface of the patch electrode 208 by the first alignment film 212a and the second alignment film 212b.

FIG. 9B shows a state in which the output signal SOUT is transmitted to the patch electrode 208 (referred to as a “second state”). In the second state, the liquid crystal molecules 216 are subjected to an electric field so that the long axis is aligned perpendicular to the surface of the patch electrode 208. The angle of the longitudinal axis of the liquid crystal molecules 216 may be aligned, depending on the magnitude of the output signal SOUT supplied to the patch electrode 208, in an intermediate direction between the horizontal and vertical directions.

In the case where the liquid crystal molecules 216 have a positive dielectric anisotropy, the dielectric constant of the second state is greater than that of the first state. Further, in the case where the liquid crystal molecules 216 have a negative dielectric anisotropy, the apparent dielectric constant of the second state is smaller than that of the first state. The liquid crystal layer 214 having dielectric anisotropy can be considered a variable dielectric layer. The reflector unit cell 202 may be controlled to delay (or not to delay) the phase of the reflected wave utilizing the dielectric anisotropy of the liquid crystal layer 214.

### 4. Overview of Radio Wave Reflecting System 100A

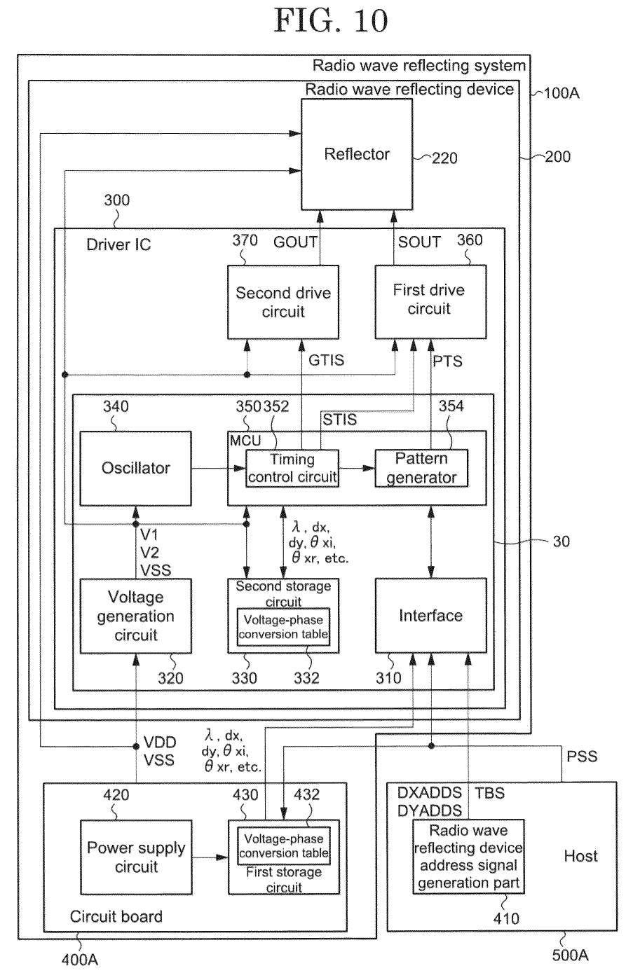

An overview of a radio wave reflecting system 100A will be described with reference to FIG. 10. FIG. 10 is a functional block diagram showing a configuration of the radio wave reflecting system 100A and a host. The description of configurations that are the same as or similar to those in FIG. 1 to FIG. 9B will be omitted here.

The radio wave reflecting system 100A is a modification of the radio wave reflecting system 100. The radio reflecting system 100A includes the radio wave reflecting device 200 and a circuit board 400A. The radio wave reflecting system 100A is different from the radio wave reflecting system 100 in including the circuit board 400A and receiving the pattern selection signal PSS, the device X coordinate signal DXADDS, the device Y coordinate signal DYADDS, and the driver position signal TBS from a host 500A. Since other configurations and functions of the radio wave reflecting system 100A are similar to those of the radio wave reflecting system 100, differences from those of the radio wave reflecting system 100 will be mainly described here.

The circuit board 400A includes the power supply circuit 420 and the first storage circuit 430. The circuit board 400A is electrically connected to the radio wave reflecting device 200 and the host 500A. The host 500A includes the radio wave reflecting device address signal generation part 410. Since the radio wave reflecting device address signal generation part 410, the power supply circuit 420, the first storage circuit 430, and the radio wave reflecting device 200 have configurations and functions similar to those of the radio wave reflecting system 100, detailed explanation thereof will be omitted here.

The MCU 350 receives the device X coordinate signal DXADDS, the device Y coordinate signal DYADDS, and the driver position signal TBS from the host 500A via the interface 310.

The radio wave reflecting system 100A receives the device X coordinate signal DXADDS, the device Y coordinate signal DYADDS, and the driver position signal TBS from the host 500A. The configuration of the radio wave reflecting system 100A can reduce the radio wave reflecting device address signal generation part 410 from the configuration of the radio wave reflecting system 100. Therefore, the radio wave reflecting system 100A (radio wave reflecting device 200) can operate with a simple configuration.

### 5. Overview of Radio Wave Reflecting Device 200A

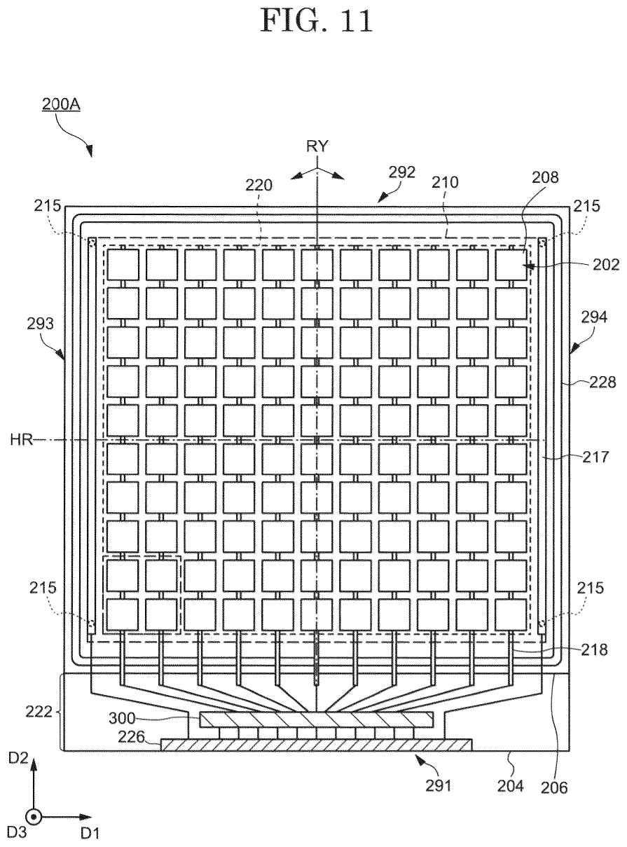

An overview of a radio wave reflecting device 200A will be described with reference to FIG. 11. FIG. 11 is a plan view showing a configuration of the radio wave reflecting device 200A. The description of configurations that are the same as or similar to those in FIG. 1 to FIG. 10 will be omitted here.

The radio wave reflecting device 200A is a modification of the radio wave reflecting device 200. The radio wave reflecting device 200A is a radio wave reflecting device capable of uniaxial reflection control. A reflection axis RY of the radio wave reflecting device 200A is uniaxial. In the radio wave reflecting device 100 including the radio wave reflecting device 200A, the reflection angle can be controlled with the reflection axis RY as the rotation axis. The radio wave reflecting device 200A includes a configuration capable of uniaxial reflection control with respect to the radio wave reflecting device 200, and does not include at least the array layer 280, the plurality of second wirings 232, and the second drive circuit 370. Other configurations of the radio wave reflecting device 200A are similar to those of the radio wave reflecting device 200.

### Second Embodiment

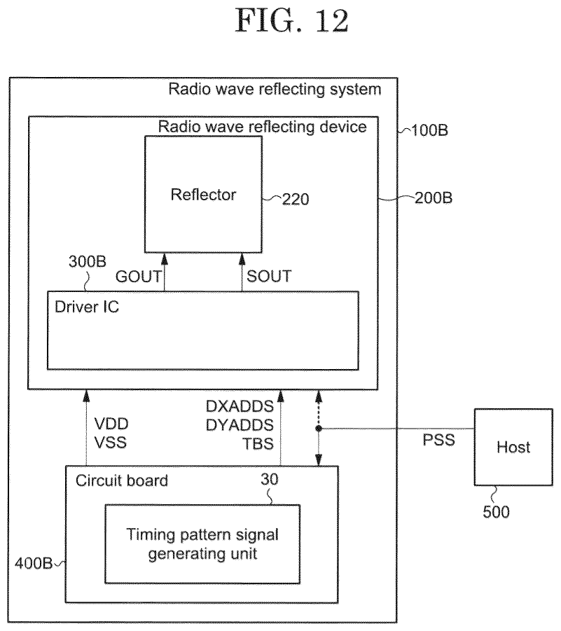

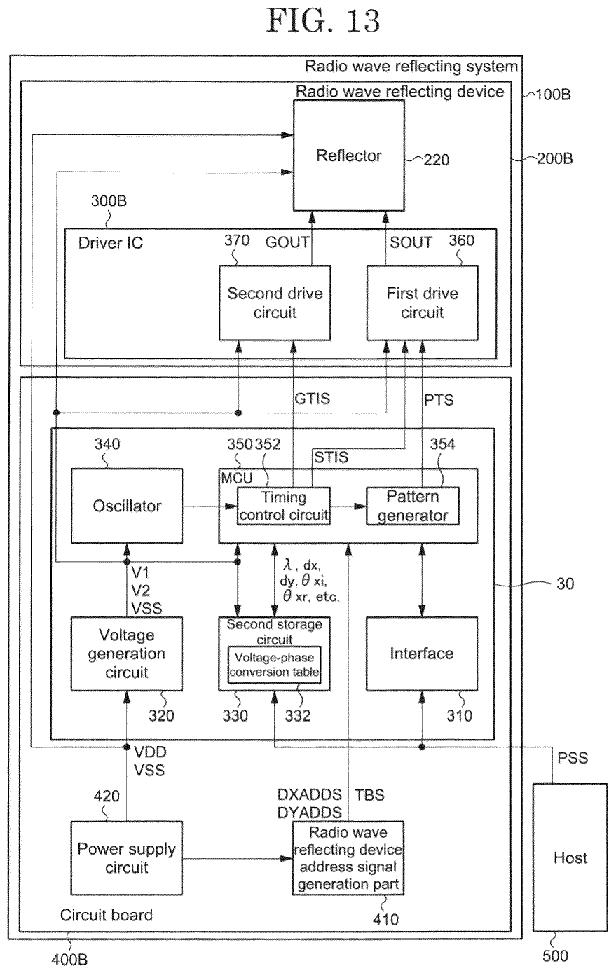

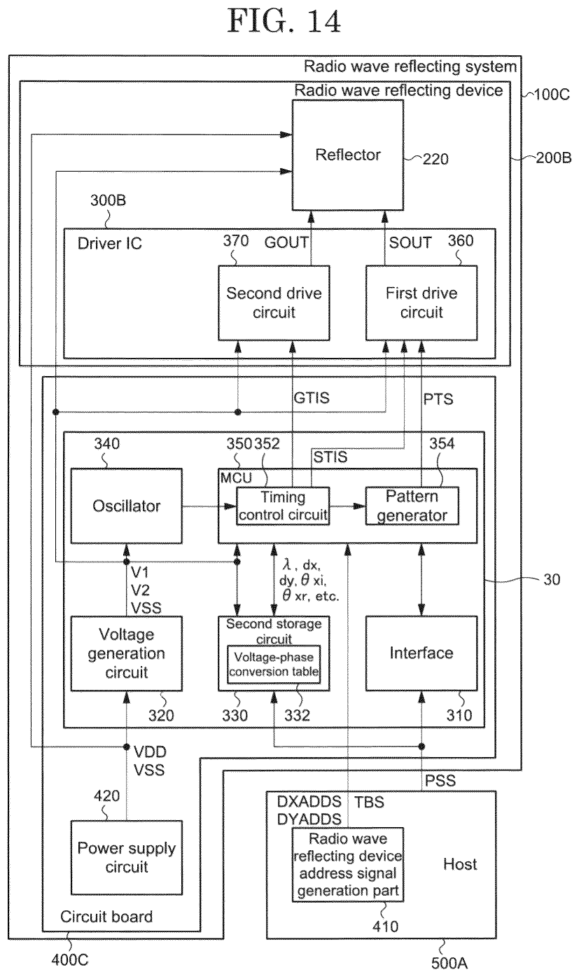

The radio wave reflecting system according to the second embodiment includes a configuration different from that of the radio wave reflecting system 100 according to the first embodiment. The radio wave reflecting system according to the second embodiment is different from the radio wave reflecting system 100 in that the circuit board includes the timing pattern signal generating unit 30 and does not include the first storage circuit 430. The radio wave reflecting system according to the second embodiment will be described with reference to FIG. 12 to FIG. 14. FIG. 12 and FIG. 13 are functional block diagrams showing a configuration of a radio wave reflecting system 100B and a host, and FIG. 14 is a functional block diagram showing a configuration of a radio wave reflecting system 100C and a host which is a modification of the radio wave reflecting system 100B.

### [2-1. Configuration of Radio Wave Reflecting Device 100B]

The radio wave reflecting system 100B is different from the radio wave reflecting system 100 in that a circuit board 400B includes the timing pattern signal generating unit 30 and does not include the first storage circuit 430. Since the other points of the radio wave reflecting system 100B are similar to those of the radio wave reflecting system 100, differences from the radio wave reflecting system 100 will be mainly described here.

As shown in FIG. 13 and FIG. 14, the radio wave reflecting system 100B includes a radio wave reflecting device 200B and the circuit board 400B. The radio wave reflecting device 200B includes the reflector 220 and a driver IC 300B. The driver IC 300B includes the first drive circuit 360 and the second drive circuit 370. The circuit board 400B includes the printed circuit board 402 (see FIG. 4), the timing pattern signal generating unit 30, the power supply circuit 420, and the radio wave reflecting device address signal generation part 410. The timing pattern signal generating unit 30 includes the interface 310, the voltage generation circuit 320, the second storage circuit 330, the oscillator 340, and the MCU 350. The timing pattern signal generating unit 30, the power supply circuit 420, and the radio wave reflecting device address signal generation part 410 are mounted on the printed circuit board 402.

Since the respective configurations and functions of the reflector 220, the interface 310, the voltage generation circuit 320, the second storage circuit 330, the oscillator 340, the MCU 350, the first drive circuit 360, the second drive circuit 370, the power supply circuit 420, and the radio wave reflecting device address signal generation part 410 are similar to those described in the first embodiment with reference to FIG. 1 to FIG. 10, descriptions thereof will be omitted here.

The circuit board 400B includes the timing pattern signal generating unit 30 in the radio wave reflecting system 100B. Therefore, the circuit board 400B receives the pattern selection signal PSS from the host 500, and generates the pattern signal PTS and the timing adjustment signals (the gate timing adjustment signal GTIS and the source timing adjustment signal STIS) generated by the driver IC 300 in the radio wave reflecting system 100.

More specifically, since the radio wave reflecting system 100B does not include the first storage circuit 430, the second storage circuit 330 and the interface 310 receive the pattern selection signal PSS from the host 500, and the MCU 350 generates the pattern signal PTS and the timing adjustment signals (the gate timing adjustment signal GTIS and the source timing adjustment signal STIS).

The circuit board 400B includes the timing pattern signal generating unit 30 in the radio wave reflecting system 100B. As a result, the radio wave reflecting system 100B can receive the pattern selection signal PSS from the host 500 and generate a signal to reflect the incident radio wave in a predetermined direction based on the pattern selection signal PSS. That is, the radio wave reflecting system 100B is operable with a small number of signal inputs. Therefore, the radio wave reflecting system 100B can operate with a simple configuration.

### [2-2. Configuration of Radio Wave Reflecting Device 100C]

As shown in FIG. 14, the radio wave reflecting system 100C is different from the radio wave reflecting system 100 in that a circuit board 400C includes the timing pattern signal generating unit 30 and does not include the first storage circuit 430. In addition, the radio wave reflecting system 100C receives the pattern selection signal PSS, the device X coordinate signal DXADDS, the device Y coordinate signal DYADDS, and the driver position signal TBS from the host 500A including the radio wave reflecting device address signal generation part 410. Since the other points of the radio wave reflecting system 100C are similar to those of the radio wave reflecting system 100 or the radio wave reflecting system 100B, descriptions thereof will be omitted here. Further, since the host 500A includes the radio wave reflecting device address signal generation part 410, the timing pattern signal generating unit 30 and the power supply circuit 420 are mounted on the printed circuit board 402 of the radio wave reflecting device system 100C.

The circuit board 400C includes the timing pattern signal generating unit 30 in the radio wave reflecting system 100C. As a result, the radio wave reflecting system 100B can receive the pattern selection signal PSS, the device X coordinate signal DXADDS, the device Y coordinate signal

DYADDS, and the driver position signal TBS from the host 500, and can generate a signal to reflect the incident radio wave in a predetermined direction based on the received signals. In other words, the radio wave reflecting system 100B is operable with a small number of signal inputs. Therefore, the radio wave reflecting system 100C can operate with a simple configuration.

### Third Embodiment

A radio wave reflecting system 100D according to the third embodiment includes a plurality of radio wave reflecting devices 200. For example, the plurality of radio wave reflecting devices 200 is arranged (tiled) in a matrix in the direction D1 and the direction D2. The radio wave reflecting system 100D is a system in which the plurality of radio wave reflecting devices 200 is arranged in a matrix in the direction D1 and the direction D2 so as to be continuous with each other, the plurality of radio wave reflecting devices 200 forms an electric equilateral plane with each other, and the radio wave can be reflected using the equilateral plane.

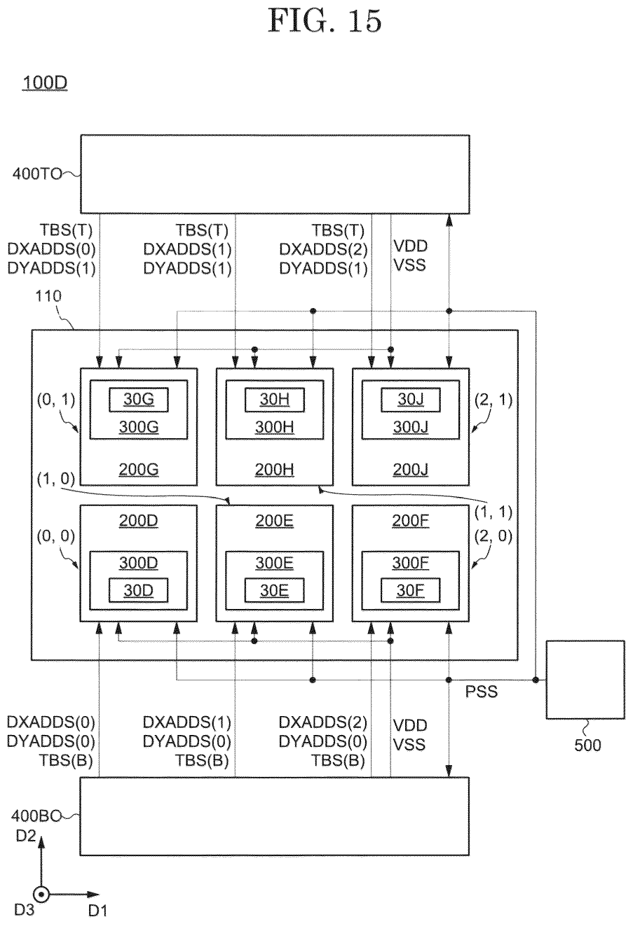

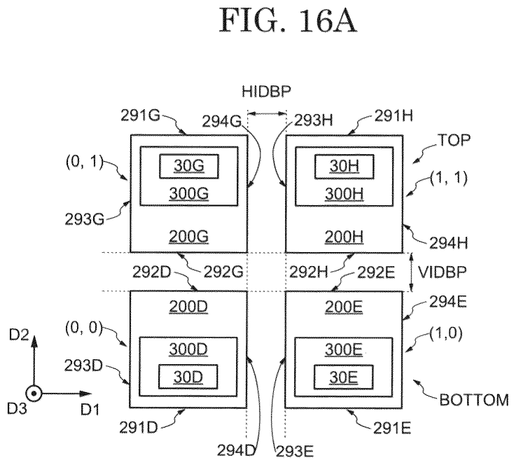

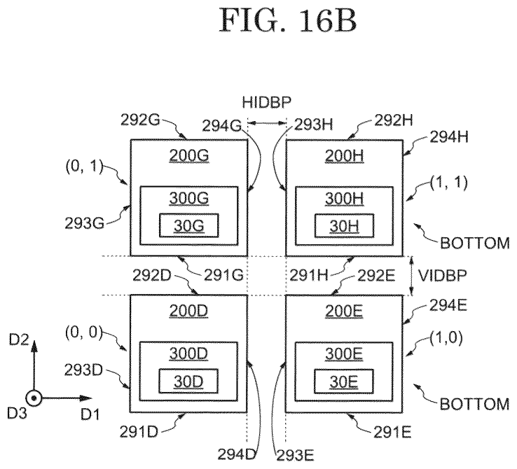

An overview of the radio wave reflecting system 100D will be described with reference to FIG. 4, FIG. 15, and FIG. 16B. FIG. 15 to FIG. 16B are functional block-diagrams showing the radio wave reflecting system 100D. Detailed descriptions of configurations that are the same as or similar to those in FIG. 1 to FIG. 14 will be omitted. Descriptions will be given with reference to figures other than FIG. 15 to FIG. 16B as necessary.

As shown in FIG. 15, the radio wave reflecting system 100D includes a substrate 110 including the plurality of radio wave reflecting devices 200D to 200H and 200J, a circuit board 400TO, and a circuit board 400BO.

For example, since the configurations and functions of each of the plurality of radio wave reflecting devices 200D to 200H and 200J are similar to those of the radio wave reflecting device 200 described with reference to FIG. 1 to FIG. 10 in the “First Embodiment”, detailed explanation thereof will be omitted here. In addition, for example, since the respective configurations and functions of the circuit board 400TO and the circuit board 400BO are similar to those of the circuit board 400 described with reference to FIG. 1 to FIG. 10 in the “First Embodiment”, detailed explanation thereof will be omitted here. Further, the respective configurations and functions of the plurality of radio wave reflecting devices 200D to 200H and 200J and the respective configurations and functions of the circuit board 400TO and the circuit board 400BO may be replaced with the configurations and functions described with reference to FIG. 12 to FIG. 14 in the “Second Embodiment” as long as there is no contradiction.

The plurality of radio wave reflecting devices 200D to 200H and 200J are arranged on the substrate 110 in a matrix in the direction D1 and the direction D2. For example, in the radio wave reflecting system 100D shown in FIG. 15, when the substrate 110 is divided into H rows and V columns (the numerical values H and V are positive integers) in a matrix in the direction D1 and the direction D2, the coordinates where the plurality of radio wave reflecting devices is arranged are represented by coordinates (H, V).

As shown in FIG. 15, for example, the radio wave reflecting device 200D is arranged (tiled) at coordinates (0, 0), the radio wave reflecting device 200E is arranged at coordinates (1, 0), the radio wave reflecting device 200F is arranged at coordinates (2, 0), the radio wave reflecting device 200G is arranged at coordinates (0, 1), the radio wave reflecting device 200H is arranged at coordinates (1, 1), and the radio wave reflecting device 200J is arranged at coordinates (2, 1).

The radio wave reflecting device 200D includes a driver IC 300D including a timing pattern signal generating unit 30G, and the radio wave reflecting device 200E includes a driver IC 300E including a timing pattern signal generating unit 30E. As shown in FIG. 15, each of the radio wave reflecting devices 200F to 200H and 200J includes the driver IC including the timing pattern signal generating unit corresponding to each of the radio wave reflecting device 200D and the radio wave reflecting device 200E.

As shown in FIG. 15 or FIG. 16A, the driver IC 300D is arranged on a first side 291D in the radio wave reflecting device 200D, the driver IC 300E is arranged on a first side 291E in the radio wave reflecting device 200E, and a driver IC 300F is arranged on the first side 291 (not shown) similar to the driver IC 300D and the driver IC 300E in the radio wave reflecting device 200F.

Similarly, the driver IC 300G is arranged on a first side 291G in the radio wave reflecting device 200G, the driver IC 300H is arranged on a first side 291H in the radio wave reflecting device 200H, and the driver IC 300J is arranged on the first side 291 (not shown) similar to the driver IC 300G and the driver IC 300H in the radio wave reflecting device 200J.

A second side 292D of the radio wave reflecting device 200D is arranged parallel to and opposite to a second side 292G of the radio wave reflecting device 200G. The radio wave reflecting device 200E is arranged next to the radio wave reflecting device 200D along the direction D1, and the radio wave reflecting device 200H is arranged next to the radio wave reflecting device 200G along the direction D1.

In addition, a second side 292E of the radio wave reflecting device 200E is arranged parallel to and opposite to a second side 292H of the radio wave reflecting device 200H. The radio wave reflecting device 200F and the radio wave reflecting device 200J are arranged in the same manner as the radio wave reflecting device 200D, the radio wave reflecting device 200G, the radio wave reflecting device 200E, and the radio wave reflecting device 200H.

The driver IC 300D of the radio wave reflecting device 200D, the driver IC 300E of the radio wave reflecting device 200E, and the driver IC 300F of the radio wave reflecting device 200F are arranged below (lower side, BOTTOM shown in FIG. 16A) with respect to the direction D2.

On the other hand, the driver IC 300G of the radio wave reflecting device 200G, the driver IC 300H of the radio wave reflecting device 200H, and the driver IC 300J of the radio wave reflecting device 200J are arranged above (upper side, TOP shown in FIG. 16A) with respect to the direction D2.

As shown in FIG. 15, the circuit board 400TO is electrically connected to the radio wave reflecting devices 200G, 200H, and 200J including the driver IC arranged above. The circuit board 400BO is electrically connected to the radio wave reflecting devices 200D to 200F including the driver IC arranged below. The host 500 is electrically connected to the plurality of radio wave reflecting devices 200D to 200H and 200J, the circuit board 400TO, and the circuit board 400BO. For example, the flexible printed circuit board is used for each of the connections.

The host 500 transmits the pattern selection signal PSS to the circuit board 400TO and the circuit board 400BO. Based on the pattern selection signal PSS, the circuit board 400TO transmits the voltage VDD, the voltage VSS, a device X coordinate signal DXADDS(0), a device Y coordinate signal DYADDS(0), a device X coordinate signal DXADDS(1), a device Y coordinate signal DYADDS(1), a device X coordinate signal DXADDS(2), a driver position signal TBS(T), and a driver position signal TBS (B) to the corresponding radio wave reflecting devices 200D to 200H or 200J.

The device X coordinate signal DXADDS(0) is a signal including coordinates indicating the position of the radio wave reflecting device corresponding to row 0 (i.e., the X coordinate is 0), and the device X coordinate signal DXADDS(1) is a signal including coordinates indicating the position of the radio wave reflecting device corresponding to row 1 (i.e., the X coordinate is 1). Similarly, the device X coordinate signal DXADDS(2) to the device X coordinate signal DXADDS(H) are signals including coordinates indicating the positions of the radio wave reflecting devices corresponding to 2 rows (that is, the X coordinate is 2) to H rows (that is, the X coordinate is H), and the device Y coordinate signal DYADDS(0) to a device Y coordinate signal DYADDS(V) are signals including coordinates indicating the positions of the radio wave reflecting devices corresponding to column 0 (that is, the Y coordinate is 0) to column V (that is, the Y coordinate is V). In addition, the driver position signal TBS(T) is a signal indicating that the driver IC is arranged above (TOP) in the radio wave reflecting device 200, and the driver position signal TBS(B) is a signal indicating that the driver IC is arranged below (BOTTOM) in the radio wave reflecting device 200.

Therefore, for example, the device X coordinate signal DXADDS(0) is transmitted to the radio wave reflecting devices 200D and 200G with the X coordinate of 0, and the device Y coordinate signal DYADDS(1) is transmitted to the radio wave reflecting devices 200G, 200H, and 200J with the Y coordinate of 1. In addition, the driver position signal TBS(B) is transmitted to the radio wave reflecting devices 200D to 200F. Similar to the device X coordinate signal DXADDS(0), the device Y coordinate signal DYADDS(1), and the driver position signal TBS(B), the other signals are transmitted to the corresponding radio wave reflecting devices.

As shown in FIG. 16A and FIG. 16B, a distance between two adjacent radio wave reflecting devices 200 (e.g., the radio wave reflecting devices 200D and 200E) along the direction D1 is a horizontal inter-device invalid distance HIDBP, and a distance between two adjacent radio wave reflecting devices 200 (e.g., the radio wave reflecting devices 200D and 200G) along the direction D2 is a vertical inter-device invalid distance VIDBP.

As shown in FIG. 4, the horizontal inter-device invalid distance HIDBP and the vertical inter-device invalid distance VIDBP are included in the plurality of parameters required to generate the pattern signal PTS and the timing adjustment signal. The horizontal inter-device invalid distance HIDBP and the vertical inter-device invalid distance VIDBP are stored in the first storage circuit 430 and the second storage circuit 330. For example, the horizontal inter-device invalid distance HIDBP and the vertical inter-device invalid distance VIDBP are read out to the MCU 350 as necessary, based on the pattern selection signal PSS similar to the other plurality of parameters.

In the case where the radio wave reflecting device system includes the plurality of radio wave reflecting devices, the phases (phase difference) of the plurality of radio wave reflecting devices are adjusted. Since the reflection direction of the radio wave changes depending on the position where the plurality of radio wave reflecting devices is arranged, a parameter for specifying the position where the plurality of radio wave reflecting devices is arranged is required. To specify the position where the plurality of radio wave reflecting devices is arranged, not only the coordinates where each of the plurality of radio wave reflecting devices is arranged, but also parameters such as a distance between the plurality of radio wave reflecting devices are required. That is, in the case where the reflection direction of the radio wave is controlled using the radio wave reflecting system, the coordinates where each of the plurality of radio wave reflecting devices is arranged, the horizontal inter-device invalid distance HIDBP, the vertical inter-device invalid distance VIDBP, the device X coordinate signal DXADDS, the device Y coordinate signal DXADDS, and the driver position signal TBS are required.

The radio wave reflecting system 100D includes the plurality of parameters including the horizontal inter-device invalid distance HIDBP, the vertical inter-device invalid distance VIDBP, the device X coordinate signal DXADDS, the device Y coordinate signal DXADDS, and the driver position signal TBS shown in FIG. 4, and can adjust the phase (voltage) of the reflector 220 included in each radio wave reflecting device 200 based on the plurality of parameters. Therefore, the radio wave reflecting system 100D includes a configuration in which the plurality of radio wave reflecting devices 200 can form an electric equilateral plane with each other, and is a system capable of reflecting radio waves using the equilateral plane, and is a radio wave reflecting system with higher accuracy.

In addition, the plurality of radio wave reflecting devices 200D to 200H and 200J may have a configuration arranged as shown in FIG. 16B. Further, although FIG. 16B shows the arrangement of the plurality of radio wave reflecting devices 200D, 200E, 200G, and 200H, other radio wave reflecting devices are also arranged similar to the plurality of radio wave reflecting devices 200D, 200E, 200G, and 200H.

In the example shown in FIG. 16B, in the radio wave reflecting device 200D, the driver IC 300D is arranged on the first side 291D, and in the radio wave reflecting device 200E, the driver IC 300E is arranged on the first side 291E. Similarly, in the radio wave reflecting device 200G, the driver IC 300G is arranged on the first side 291G, and in the radio wave reflecting device 200H, the driver IC 300H is arranged on the first side 291H. In addition, the second side 292D of the radio wave reflecting device 200D is arranged parallel to and opposite to the first side 291G of the radio wave reflecting device 200G. The radio wave reflecting device 200E is arranged next to the radio wave reflecting device 200D along the direction D1, and the radio wave reflecting device 200H is arranged next to the radio wave reflecting device 200G along the direction D1. The second side 292E of the radio wave reflecting device 200E is arranged parallel to and opposite to the first side 291H of the radio wave reflecting device 200H.

That is, in the example shown in FIG. 16B, the driver IC included in each of the plurality of radio wave reflecting devices is arranged below (lower side, BOTTOM shown in FIG. 16B) with respect to the direction D2.

In addition, the plurality of radio wave reflecting devices 200D to 200H and 200J may be electrically connected to the circuit board 400BO (see FIG. 15) because the driver IC is arranged below. Further, the plurality of radio wave reflecting devices 200G to 200H and 200J may be electrically connected to a circuit board (not shown) different from the circuit board 400BO.

As described above, a configuration of the radio wave reflecting system 100D may be a configuration in which the device X coordinate signal DXADDS, the device Y coordinate signal DYADDS, and the driver position signal TBS are individually transmitted to the plurality of radio wave reflecting devices. In addition, for example, the configuration of the radio wave reflecting system 100D may be a configuration in which the X coordinate, the Y coordinate, and the driver position of the radio wave reflecting device are combined into data and stored in the first storage circuit 430 or the second storage circuit 330. The circuit board 400BO or 400TO reads the data obtained by combining the X coordinate, the Y coordinate, and the driver position of the corresponding radio wave reflecting device based on the pattern selection signal PSS transmitted from the host 500. Further, the circuit board 400BO or 400TO can generate the pattern signal PTS including the data obtained by combining the X-coordinate, the Y-coordinate, and the driver position of the radio wave reflecting device based on the data obtained by combining the X-coordinate, the Y-coordinate, and the driver position of the radio wave reflecting device.

For example, a conventional radio wave reflecting system different from the radio wave reflecting system of the present invention needs to transmit signals corresponding to the X coordinate, the Y coordinate, and the driver position of the radio wave reflecting device to the driver IC 300. On the other hand, for example, the circuit board 400BO or 400TO of a radio wave reflecting system 400D can generate the pattern signal PTS including data obtained by combining the X coordinate, the Y coordinate, and the driver position of the radio wave reflecting device, and transmit the pattern signal PTS to the driver IC 300. As a result, the radio wave reflecting system 400D is capable of reducing the number of signals input to the driver IC 300 and reducing the number of terminals in the driver IC 300.

The configurations of the radio wave reflecting system exemplified as an embodiment of the present invention can be combined as long as there is no contradiction. The configurations of the radio wave reflecting system exemplified as an embodiment of the present invention can be interchanged and combined as long as there is no contradiction. Further, the addition, deletion, or design change of components, or the addition, deletion, or condition change of processes as appropriate by those skilled in the art based on the radio wave reflecting system are also included in the scope of the present invention as long as they are provided with the gist of the present invention.

Further, it is understood that, even if the effect is different from those provided by each of the above-described embodiments, the effect obvious from the description in the specification or easily predicted by persons ordinarily skilled in the art is apparently derived from the present invention.

What is claimed is:

1. A radio wave reflecting system comprising:
an intelligent reflecting surface including a plurality of patch electrodes arranged in a matrix in a first direction and a second direction intersecting the first direction, an electrode layer facing and spaced apart from the plurality of patch electrodes, and a liquid crystal layer provided between the plurality of patch electrodes and the electrode layer; and
a driver IC electrically connected to the plurality of patch electrodes, including an output signal generating unit and a timing pattern signal generating unit electrically connected to the output signal generating unit;
wherein
the timing pattern signal generating unit is configured to generate a plurality of pattern signals including voltage values corresponding to each of a plurality of predetermined phase values using an address signal indicating a position where the intelligent reflecting surface is arranged, a power supply voltage, and a pattern selection signal selecting a plurality of parameters including the plurality of predetermined phase values, and
the output signal generating unit is configured to generate a plurality of output signals based on each of the plurality of pattern signals using the plurality of pattern signals, and to supply each of the plurality of output signals to the corresponding plurality of patch electrodes.

2. The radio wave reflecting system according to claim 1, wherein
the timing pattern signal generating unit includes a storage circuit for storing a conversion table for converting the plurality of predetermined phase values into voltage values corresponding to each of the plurality of predetermined phase values, and a plurality of data corresponding to the plurality of parameters.

3. The radio wave reflecting system according to claim 2, wherein
the timing pattern signal generating unit is configured to generate a timing adjustment signal for adjusting the timing of supplying signals to the plurality of patch electrodes, using a plurality of parameters including the plurality of predetermined phase values.

4. The radio wave reflecting system according to claim 1, wherein
the intelligent reflecting surface includes a part of a first substrate,
the first substrate includes a first side parallel to the first direction and a second side opposite to the first side, and
the driver IC is arranged on the first substrate and arranged on either the first side or the second side.

5. The radio wave reflecting system according to claim 1, wherein
the radio wave reflecting system includes a circuit board electrically connected to the driver IC, and
the circuit board is configured to generate the address signal and the power supply voltage and supply the address signal and the power supply voltage to the timing pattern signal generating unit.

6. The radio wave reflecting system according to claim 5, wherein
the circuit board is configured to generate a driver IC position signal including data indicating whether the driver IC is arranged on the first side or the second side, and supply the driver IC position signal to the timing pattern signal generating unit.

7. The radio wave reflecting system according to claim 5, wherein
each of the plurality of patch electrodes is capable of reflecting a radio wave, and
the plurality of parameters includes an incident angle of the radio wave, a reflection angle of the radio wave, and a distance between adjacent patch electrodes among the plurality of patch electrodes.

8. A radio wave reflecting system comprising:
an intelligent reflecting surface including a plurality of patch electrodes arranged in a matrix in a first direction and a second direction intersecting the first direction, an electrode layer facing and spaced apart from the plurality of patch electrodes, and a liquid crystal layer provided between the plurality of patch electrodes and the electrode layer;
a driver IC electrically connected to the plurality of patch electrodes; and
a circuit board electrically connected to the driver IC and including a timing pattern signal generating unit;
wherein
the timing pattern signal generating unit is configured to generate a plurality of pattern signals including voltage values corresponding to each of a plurality of predetermined phase values using an address signal indicating a position where the intelligent reflecting surface is arranged, a power supply voltage, and a pattern selection signal selecting a plurality of parameters including the plurality of predetermined phase values, and
the driver IC is configured to generate a plurality of output signals based on each of the plurality of pattern signals using the plurality of pattern signals, and to supply each of the plurality of output signals to the corresponding plurality of patch electrodes.

9. The radio wave reflecting system according to claim 8, wherein
the timing pattern signal generating unit includes a storage circuit for storing a conversion table for converting the plurality of predetermined phase values into voltage values corresponding to each of the plurality of predetermined phase values, and a plurality of data corresponding to the plurality of parameters.

10. The radio wave reflecting system according to claim 9,
the timing pattern signal generating unit is configured to generate a timing adjustment signal for adjusting the timing of supplying signals to the plurality of patch electrodes by using a plurality of parameters including the plurality of predetermined phase values.

11. The radio wave reflecting system according to claim 8, wherein
the intelligent reflecting surface includes a part of a first substrate,
the first substrate includes a first side parallel to the first direction and a second side opposite to the first side, and
the driver IC is arranged on the first substrate and arranged on either the first side or the second side.

12. The radio wave reflecting system according to claim 11, wherein
the circuit board includes an address signal generating unit and a power supply circuit,
the address signal generating unit is configured to generate the address signal using the pattern selection signal and transmit the address signal to the timing pattern signal generating unit, and
the power supply circuit is configured to generate the power supply voltage and supply the power supply voltage to the timing pattern signal generating unit.

13. The radio wave reflecting system according to claim 12, wherein
the address signal generating unit is configured to generate a driver IC position signal including data indicating whether the driver IC is arranged on the first side or the second side, and to supply the driver IC position signal to the timing pattern signal generating unit.

14. The radio wave reflecting system according to claim 8, wherein
each of the plurality of patch electrodes is capable of reflecting a radio wave, and
the plurality of parameters includes an incident angle of the radio wave, a reflection angle of the radio wave, and a distance between adjacent patch electrodes among the plurality of patch electrodes.

15. A radio wave reflecting system comprising:
a first radio wave reflecting device;
a second radio wave reflecting device arranged alongside the first radio wave reflecting device along a second direction intersecting a first direction;
a third radio wave reflecting device arranged alongside the first radio wave reflecting device along the first direction;
a fourth radio wave reflecting device arranged alongside the second radio wave reflecting device along the first direction and alongside the third radio wave reflecting device along the second direction;
a first circuit board connected to the first radio wave reflecting device and the second radio wave reflecting device; and
a second circuit board connected to the third radio wave reflecting device and the fourth radio wave reflecting device,
wherein
each of the first circuit board and the second circuit board includes an address signal generating unit and a power supply circuit,
wherein
the address signal generating unit is configured to generate an address signal indicating positions where the first to fourth radio wave reflecting devices are arranged using a pattern selection signal for selecting a plurality of parameters including a plurality of predetermined phase values, and
the power supply circuit is configured to generate a power supply voltage,
each of the first circuit board and the second circuit board is configured to supply the address signal and the power supply voltage to the corresponding first to fourth radio wave reflecting devices,
each of the first to fourth radio wave reflecting devices includes
an intelligent reflecting surface including a plurality of patch electrodes arranged in a matrix in the first direction and the second direction, an electrode layer facing and spaced apart from the plurality of patch electrodes, and a liquid crystal layer provided between the plurality of patch electrodes and the electrode layer,
a driver IC electrically connected to the plurality of patch electrodes and including an output signal generating unit and a timing pattern signal generating unit,
a first side facing the first direction and arranged parallel to the second direction; and
a second side arranged parallel to the first side,
the timing pattern signal generating unit included in each of the first to fourth radio wave reflecting devices is configured to generate a plurality of pattern signals including voltage values corresponding to each of the plurality of predetermined phase values using the address signal, the power supply voltage, and the pattern selection signal, and
the output signal generating unit included in each of the first to fourth radio wave reflecting devices is configured to generate a plurality of output signals based on each of the plurality of pattern signals using the corresponding plurality of pattern signals, and to supply each of the plurality of output signals to the corresponding plurality of patch electrodes.

16. The radio wave reflecting system according to claim 15, wherein
the driver IC included in each of the first to fourth radio wave reflecting devices is arranged on the first side.

17. The radio wave reflecting system according to claim 16, wherein
the address signal generating unit included in the first circuit board is configured to generate a first driver IC position signal including data indicating that the driver IC included in each of the first radio wave reflecting device and the second radio wave reflecting device is arranged on the first side, and is configured to supply the address signal and power supply voltage corresponding to each of the first radio wave reflecting device and the second radio wave reflecting device, and the first driver IC position signal to the driver IC included in each of the first radio wave reflecting device and the second radio wave reflecting device,
the address signal generating unit included in the second circuit board is configured to generate a second driver IC position signal including data indicating that the driver IC included in each of the third radio wave reflecting device and the fourth radio wave reflecting device is arranged on the first side, and is configured to supply the address signal and power supply voltage corresponding to each of the third radio wave reflecting device and the fourth radio wave reflecting device, and the second driver IC position signal to the driver IC included in each of the third radio wave reflecting device and the fourth radio wave reflecting device.

18. The radio wave reflecting system according to claim 17, wherein
the first side of the first radio wave reflecting device and the second side of the third radio wave reflecting device are arranged parallel to the second direction and arranged to face each other along the first direction, and
the first side of the second radio wave reflecting device and the second side of the fourth radio wave reflecting device are arranged parallel to the second direction and arranged to face each other along the first direction.

19. The radio wave reflecting system according to claim 17, wherein
the first side of the first radio wave reflecting device and the first side of the third radio wave reflecting device are arranged parallel to the second direction and arranged to face each other along the first direction, and
the first side of the second radio wave reflecting device and the first side of the fourth radio wave reflecting device are arranged parallel to the second direction and arranged to face each other along the first direction.

20. The radio wave reflecting system according to claim 15, wherein
each of the plurality of patch electrodes is capable of reflecting radio waves, and
the plurality of parameters includes a distance between the first radio wave reflecting device and the second radio wave reflecting device, a distance between the third radio wave reflecting device and the fourth radio wave reflecting device, a distance between the first radio wave reflecting device and the third radio wave reflecting device, a distance between the second radio wave reflecting device and the fourth radio wave reflecting device, an incident angle of the radio wave, a reflection angle of the radio wave, and a distance between adjacent patch electrodes among the plurality of patch electrodes.
